(19) United States
(12) Patent Application Publication
(10) Pub. No.: US 2019/0042998 A1
(43) Pub. Date: Feb. 7, 2019

(54) PROCESS MANAGEMENT SYSTEM AND PROCESS MANAGEMENT METHOD

(71) Applicant: NEC Corporation, Minato-ku, Tokyo (JP)

(72) Inventor: Mitsuyoshi UENO, Tokyo (JP)

(73) Assignee: NEC Corporation, Minato-ku, Tokyo (JP)

(21) Appl. No.: 16/075,735

(22) PCT Filed: Feb. 22, 2017
(86) PCT No.: PCT/JP2017/006574

§ 371 Date: Aug. 6, 2018

(30) Foreign Application Priority Data
Mar. 11, 2016 (JP) 2016-048273

(51) Int. Cl. G06Q 10/06; G06Q 10/00

(52) U.S. Cl. CPC G06Q 10/063114; G06Q 10/20; G06Q 10/063112

(57) ABSTRACT

The management device 20 includes: a management reception unit 21 for receiving work-related information transmitted from the display devices 301-30n; and a management transmission unit 22 for transmitting, to the display devices 301-30n, process information indicating work process and the work-related information received by the management reception unit 21. The display device 301 includes: an input unit 31 to which the work-related information is input; a display transmission unit 32 for transmitting the received work-related information to the management device 20; a display reception unit 33 for receiving the information transmitted from the management transmission unit 22; and a display unit 34 for displaying the input work-related information and the information received by the display reception unit 33 in one display area.

### TECHNICAL FIELD

The present invention relates to a process management system and a process management method, and more particularly to a process management system and a process management method which enable workers to efficiently respond to an abnormal event and a sign of an abnormal event without interruption of information transmission between the workers and a manager.

### BACKGROUND ART

In a case where an abnormal event or a sign of an abnormal event is detected in a plant such as a power plant, a response to the detected abnormal event and a sign of an abnormal event is demanded. For the response to the abnormal event and the sign of an abnormal event, for example, a method described in Patent Literature 1 or a method described in Patent Literature 2 is used.

In Patent Literature 1, an automatic, computerized, maintenance and inspection management system is described, which is used for maintenance and traceable management of an inspection command. In Patent Literature 2, an operation support/confirmation system is described, which improves accuracy and recordability of operation and operation support of a facility and apparatus in a plant or the like, and working efficiency, and saves manpower and the like.

In a case where a response to an abnormal event and a sign of an abnormal event is made, one or a plurality of managers in a management center of a plant is required to exchange information with one or a plurality of workers who works responding to the abnormal event and the sign of an abnormal event on a plant site.

That is because work responding to the abnormal event and the sign of an abnormal event is efficiently performed. That is, transmission means usable between a plurality of staffs to smoothly transmit information has been demanded. Use of the transmission means for smoothly transmitting information enables efficient work performed by a plurality of staffs in cooperation.

As described above, when an abnormal event and a sign of an abnormal event are detected, workers in the field work responding to the abnormal event and a sign of an abnormal event, for example, while exchanging information with a manager in a management center. To make an efficient and quick response to an abnormal event and a sign of an abnormal event, resolution of the following problems is additionally required.

For example, the manager in the management center needs to determine workers depending on the contents of a detected abnormal event and sign of an abnormal event, and to immediately communicate with the determined workers. However, it is difficult for the manager in the management center who does not understand, for example, the contents of the detected event so well to quickly determine workers who can respond to the detected event.

Furthermore, for example, different workers may respond to detected abnormal events and signs of the abnormal events in different response processes. However, it is difficult for the manager in the management center who does not understand, for example, the abilities of workers so well to quickly determine workers who can respond to the detected event, for each response process.

Furthermore, for example, workers who respond to a detected abnormal event and sign of an abnormal event are required to work without skipping work, and work without interruption in information transmission with the manager in the management center. However, a method enabling workers to efficiently work as described above has not been provided.

Furthermore, for example, to make a response to a detected abnormal event and sign of an abnormal event, a worker may refer to a response record to the same type of abnormal event and sign of an abnormal event in the past. However, it is difficult for the manager in the management center or the workers in the field to quickly find out a target response record from a large amount of response records or the like.

Furthermore, for example, information transmitted between workers and the manager and the contents of performed work during a response to a detected abnormal event and sign of an abnormal event are required to be recorded against occurrence of the same type of event in the future. That is, recording means for efficiently recording transmitted information and the contents of performed work has been demanded.

Furthermore, for example, in a case where a response record of the same type of abnormal event and sign of an abnormal event in the past, the contents of which are difficult to understand, is referred to, it is difficult for a manager and workers to use the response record to efficiently and correctly work.

### CITATION LIST

### Patent Literature

PTL 1: Japanese Patent Application Laid-Open No. 2005-011315

PTL 2: Japanese Patent Application Laid-Open No. 2011-034180

PTL 3: Japanese Patent Application Laid-Open No. 2001-243349

PTL 4: Japanese Patent Application Laid-Open No. 2006-309615

### SUMMARY OF INVENTION

### Technical Problem

In the method described in Patent Literature 1 and the method described in Patent

Literature 2, management of work is taken into consideration, but smooth transmission of information between a plurality of staffs for efficient work is not considered.

As transmission means for smoothly transmitting information between a plurality of staffs, for example, means having a function enabling a text-based conversation (hereinafter, referred to as chat function) is considered. A plurality of staffs using the means having the chat function is allowed to smoothly exchange information including an image, a moving image, or the like.

In Patent Literature 3, an information providing service support device having a chat function is described. In the information providing service support device described in Patent Literature 3, reuse of a record of information exchanged between staffs is considered, but use of the chat function for work management is not considered.

In Patent Literature 4, a fault resolution support system for supporting quick response to an unknown fault is described. In the fault resolution support system described in Patent Literature 4, a chat function is used for work management.

However, in the fault resolution support system described in Patent Literature 4, inclusion of a work process in information transmitted between workers and a manager is not considered. That is, in a case where the fault resolution support system described in Patent Literature 4 is used, it is difficult for workers and a manager to clearly understand the progress of work. Furthermore, it is difficult for the manager to change a worker in charge for each work process.

Therefore, an object of the present invention is to provide a process management system and a process management method which enable workers to work while transmitting information including a work process between the workers and a manager.

### Solution to Problem

A process management system according to the present invention is a process management system including a management device for managing work, and a display device which is connected so as to be able to communicate with the management device. The management device includes a management reception unit for receiving work-related information transmitted from the display device, and a management transmission unit for transmitting, to the display device, process information indicating work process and the work-related information received by the management reception unit. The display device includes an input unit to which the work-related information is input, a display transmission unit for transmitting the received work-related information to the management device, a display reception unit for receiving the information transmitted from the management transmission unit, and a display unit for displaying the input work-related information and the information received by the display reception unit in one display area.

A process management method according to the present invention is a process management method performed in a process management system including a management device which manages work, and a display device which is connected so as to be able to communicate with the management device. The method includes causing the management device to receive work-related information transmitted from the display device, and transmit, to the display device, process information indicating work process and the received work-related information. The method includes causing the display device to receive the work-related information, transmit the received work-related information to the management device, receive the information transmitted from the management device, and display the received work-related information and the received information in one display area.

### Advantageous Effects of Invention

According to the present invention, workers can work while transmitting information including a work process between the workers and a manager.

### BRIEF DESCRIPTION OF DRAWINGS

FIG. 1 is a block diagram showing a configuration example of a first exemplary embodiment of a process management system according to the present invention.

FIG. 2 is a flowchart showing an operation of display processing by a process management system 10 according to the first exemplary embodiment.

FIG. 3 is a block diagram showing a configuration example of a second exemplary embodiment of a process management system according to the present invention

FIG. 4 is a block diagram showing a configuration example of the second exemplary embodiment of a chat-room management unit 202.

FIG. 5 is an explanatory diagram showing an example of report generated by a report generation unit 203.

FIG. 6 is an explanatory diagram showing an example of abnormal/abnormal sign classification data stored in an abnormal/abnormal sign classification-relating data storage unit 204.

FIG. 7 is an explanatory diagram showing an example of process (step) data and process (substep) data stored in a process-relating data storage unit 205.

FIG. 8 is an explanatory diagram showing an example of staff data and assigned-work data stored in a staff-relating data storage unit 206.

FIG. 9 is an explanatory diagram showing an example of response data, response process (step) data, response process (substep) data, data of remarks, and caution/information data stored in a response-relating data storage unit 207.

FIG. 10 is a block diagram showing a configuration example of the second exemplary embodiment of a display terminal 300.

FIG. 11 is an explanatory diagram showing an example of chat-room screen displayed by a chat-room-screen display unit 301.

FIG. 12 is an explanatory diagram showing an example of chat in a response given in the past, displayed in a chat area.

FIG. 13 is an explanatory diagram showing an example of abnormality classification confirmation screen displayed by an abnormality classification display unit 302.

FIG. 14 is an explanatory diagram showing an example of process list screen displayed by a process display unit 303.

FIG. 15 is an explanatory diagram showing an example of instruction screen displayed by an instruction display unit 304.

FIG. 16 is an explanatory diagram showing another example of instruction screen displayed by the instruction display unit 304.

FIG. 17 is a flowchart showing an operation of a chat-room screen display processing by a process management system 100 according to the second exemplary embodiment.

FIG. 18 is a flowchart showing an operation of data analysis processing by a caution/information data analysis unit 212 according to the second exemplary embodiment.

FIG. 19 is a flowchart showing an operation of an abnormality classification confirmation screen display processing by the abnormality classification display unit 302 according to the second exemplary embodiment.

FIG. 20 is a flowchart showing an operation of a process list screen display processing by the process display unit 303 according to the second exemplary embodiment.

FIG. 21 is a flowchart showing an operation of conversation processing by the process management system 100 according to the second exemplary embodiment.

FIG. 22 is a flowchart showing an operation of instruction processing by the process management system 100 according to the second exemplary embodiment.

FIG. 23 is a flowchart showing an operation of another instruction processing by the process management system 100 according to the second exemplary embodiment.

FIG. 24 is a flowchart showing an operation of caution/information display processing by a caution/information display unit 305 according to the second exemplary embodiment.

FIG. 25 is an explanatory diagram showing another example of chat-room screen displayed by the chat-room-screen display unit 301.

FIG. 26 is a flowchart showing an operation of another caution/information display processing by the caution/information display unit 305 according to the second exemplary embodiment.

FIG. 27 is an explanatory diagram showing another example of chat-room screen displayed by the chat-room-screen display unit 301.

FIG. 28 is an explanatory diagram showing another example of chat-room screen displayed by the chat-room-screen display unit 301.

FIG. 29 is a flowchart showing an operation of work transition processing by the process management system 100 according to the second exemplary embodiment.

FIG. 30 is a flowchart showing an operation of another work transition processing by the process management system 100 according to the second exemplary embodiment.

### DESCRIPTION OF EMBODIMENTS

### Exemplary Embodiment 1

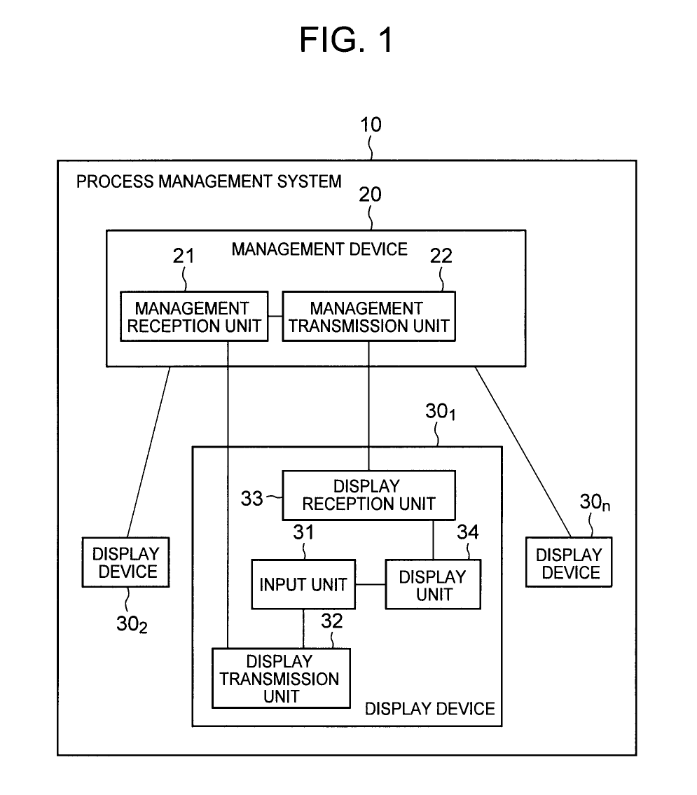

Hereinafter, exemplary embodiments of the present invention will be described with reference to the drawings. FIG. 1 is a block diagram showing a configuration example of a first exemplary embodiment of a process management system according to the present invention. The process management system 10 according to the present invention is a process management system including a management device 20 for managing work, and a display device 30₁ to a display device 30ₙ which are connected so as to be able to communicate with the management device 20. The management device 20 includes a management reception unit (management side reception unit) 21 (e.g., a chat-room management unit 202) for receiving work-related information transmitted from the display device 30₁ to the display device 30ₙ, and a management transmission unit (management side transmission unit) 22 (e.g., the chat-room management unit 202) for transmitting, to the display device 30₁ to the display device 30ₙ, process information indicating work process and the work-related information received by the management reception unit 21. The display device 30, includes an input unit 31 (e.g., a chat-room-screen display unit 301) to which the work-related information is input, a display transmission unit (display side transmission unit) 32 (e.g., the chat-room-screen display unit 301) for transmitting the received work-related information to the management device 20, a display reception unit (display side reception unit) 33 (e.g., the chat-room-screen display unit 301) for receiving the information transmitted from the management transmission unit 22, and a display unit 34 (e.g., the chat-room-screen display unit 301) for displaying the input work-related information and the information received by the display reception unit 33 in one display area.

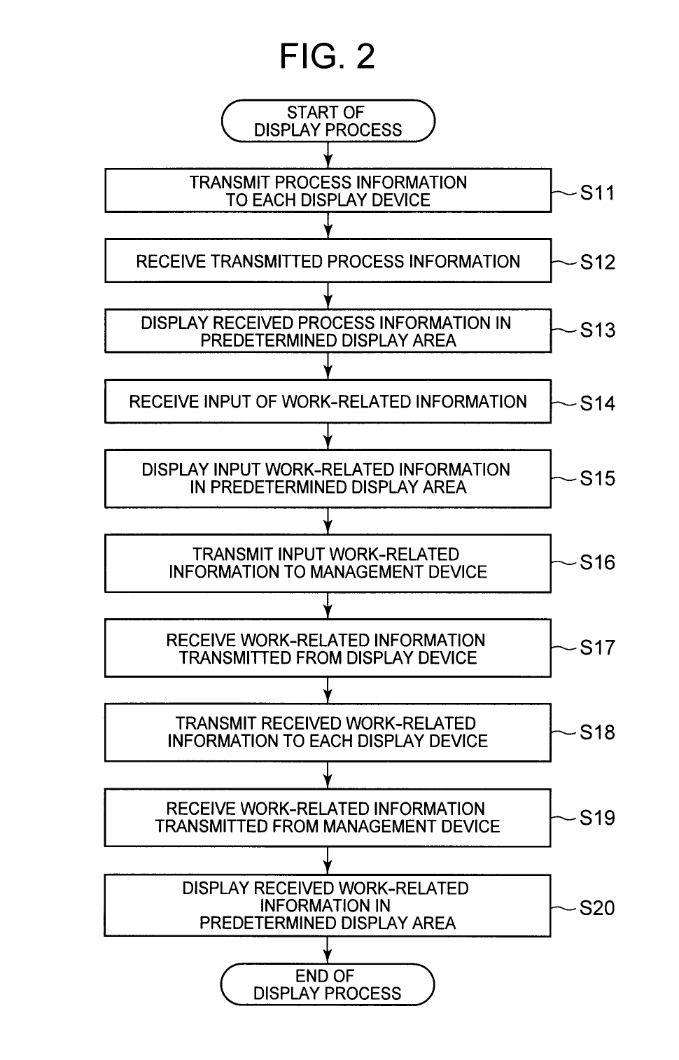

Hereinafter, a display process performed by the process management system 10 will be described. FIG. 2 is a flowchart showing an operation of display processing by the process management system 10 according to the first exemplary embodiment. The management transmission unit 22 transmits process information representing a process of work performed in a response to a detected abnormal event or sign of an abnormal event to the display device 30₁ to the display device 30ₙ respectively (step S11).

Then, the display reception unit 33 of the display device 30₁ receives the process information transmitted from the management transmission unit 22 (step S12). The display unit 34 of the display device 30₁ has a predetermined display area to display received process information (step S13).

Then, the input unit 31 of the display device 30₁ receives input of work-related information (step S14). The display unit 34 of the display device 30₁ displays the input work-related information in a predetermined display area (step S15). Then, the display transmission unit 32 of the display device 30₁ transmits the input work-related information to the management device 20 (step S16).

Then, the management reception unit 21 of the management device 20 receives the work-related information transmitted from the display device 30₁ (step S17). The management transmission unit 22 transmits work-related information transmitted from the respective display devices and received by the management reception unit 21, to the display device 30₁ to the display device 30ₙ respectively (step S18).

Then, the display reception unit 33 of the display device 30₁ receives the work-related information transmitted from the management transmission unit 22 (step S19). The display unit 34 of the display device 30₁ has a predetermined display area to display the received work-related information (step S20). After display, the process management system 10 finishes the display process.

Use of a process management system having such a configuration enables workers to work while transmitting information including a work process between the workers and a manager.

Furthermore, the management transmission unit 22 may transmit past information indicating a past working status to the display device 30₁ to the display device 30ₙ.

Such a configuration enables the process management system to provide information indicating a response status in the past for workers.

Furthermore, the management transmission unit 22 may transmit work information indicating the contents of the whole work to the display device 30₁ to the display device 30ₙ.

Such a configuration enables the process management system to provide information indicating the contents of the whole work for workers.

Furthermore, the management transmission unit 22 may transmit caution information indicating cautions relating to work to the display device 30₁ to the display device 30ₙ.

Such a configuration enables the process management system to provide information indicating cautions relating to work for workers.

Furthermore, the management transmission unit 22 may transmit difference information indicating a difference between a working status indicated by past information and a working status indicated by work-related information received by the management reception unit 21 to the display device 30₁ to the display device 30ₙ.

Such a configuration enables the process management system to provide information indicating a difference between a current response status and a response status in the past to workers.

Furthermore, the input unit 31 may receive input of instruction information indicating instructions to perform a process of work to be performed.

Such a configuration enables the process management system to cause a manager to input instructions to advance a process of work.

Furthermore, the input unit 31 may receive input of completion information indicating the completion of a process of work.

Such a configuration enables the process management system to cause a worker to input information about completion of work.

Furthermore, the management device 20 may include a generation unit (e.g., report generation unit 203) for generating a report on the basis of work-related information received by the management reception unit 21.

Such a configuration enables the process management system to save the trouble of a worker to generate a report representing a response content.

### Exemplary Embodiment 2

### Description of Configuration

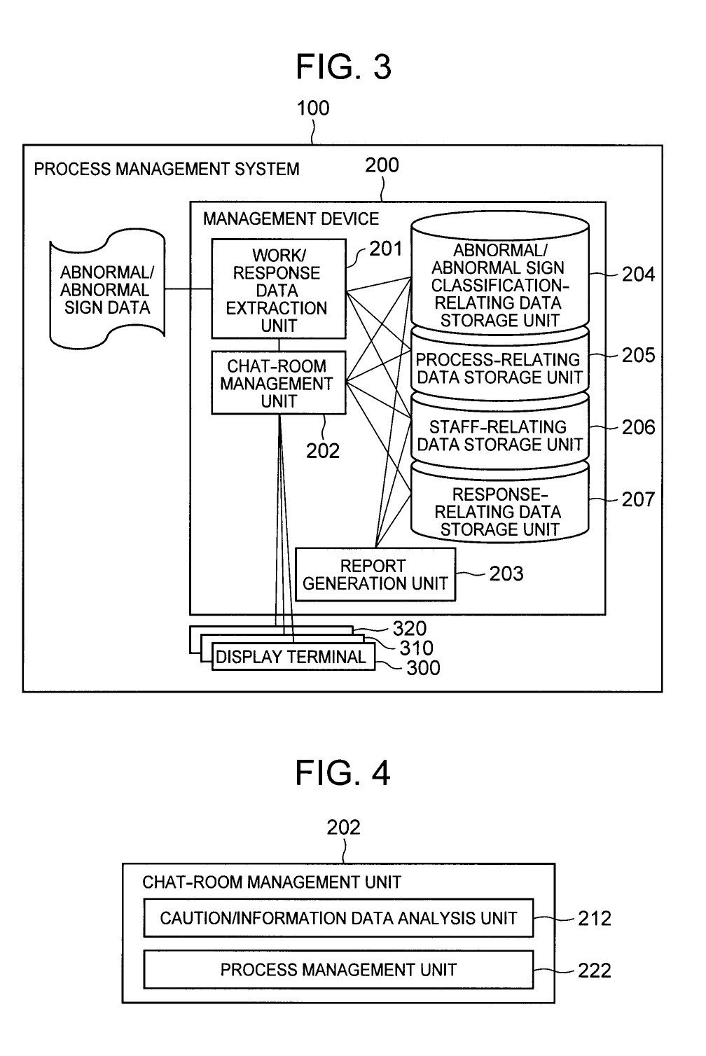

Next, a second exemplary embodiment of the present invention will be described with reference to the drawings. FIG. 3 is a block diagram showing a configuration example of a second exemplary embodiment of a process management system according to the present invention.

The process management system 100 according to the present exemplary embodiment is a system for managing a work process. The process management system 100 includes a device group enabling a chat between a plurality of staffs. The device group includes a management device for managing data, and display terminals with display screens of the staffs.

The display terminals of the staffs display a chat-room screen for a chat conversation between participants. A participant is allowed to exchange information with another participant via the displayed chat-room screen.

As showed in FIG. 3, the process management system 100 according to the present exemplary embodiment includes a management device 200, and a display terminal 300 to a display terminal 320.

The management device 200 functions to manage a chat room and to manage various data. As showed in FIG. 3, when receiving abnormal/abnormal sign data, the management device 200 transmits instructions to display the chat-room screen to each display terminal. Note that the abnormal/abnormal sign data is data representing an abnormal event or a sign of an abnormal event.

When the abnormal/abnormal sign data is input, the management device 200 extracts information representing a registered work process on the basis of classification indicated by the input data. Then, on the basis of the work process represented by the extracted information, the management device 200 identifies the manager in the management center and workers in the field who are in charge of the work process.

After identifying persons in charge of the work process, the management device 200 transmits instructions to display the chat-room screen in which a plurality of staffs as the identified persons in charge participates as participants, to each display terminal of each staff. Via the displayed chat-room screen, each person in charge of the work process is allowed to quickly communicate with another person with whom the person desires to communicate, after the abnormal event or the sign of an abnormal event is detected.

The display terminal is a terminal of each staff. The display terminal is communicably connected to the management device 200 via a communication network or the like. Note that, in FIG. 3, three display terminals, that is, the display terminal 300 to the display terminal 320, are showed, but the number of display terminals included in the process management system 100 is not limited to three.

As showed in FIG. 3, the management device 200 includes a work/response data extraction unit 201, a chat-room management unit 202, a report generation unit 203, an abnormal/abnormal sign classification-relating data storage unit 204, a process-relating data storage unit 205, a staff-relating data storage unit 206, and a response-relating data storage unit 207. That is, the management device 200 manages a plurality of types of data.

The work/response data extraction unit 201 receives abnormal/abnormal sign data from outside the management device 200. The work/response data extraction unit 201 extracts data representing a classification of the abnormal event or a classification of the sign of an abnormal event represented by the received abnormal/abnormal sign data, from the abnormal/abnormal sign classification-relating data storage unit 204.

Then, the work/response data extraction unit 201 extracts work-relating data corresponding to the extracted data representing a classification of the abnormal event or a classification of the sign of an abnormal event from the process-relating data storage unit 205, and extracts staff-relating data corresponding to the extracted data from the staff-relating data storage unit 206 respectively. The work/response data extraction unit 201 inputs the extracted data to the chat-room management unit 202.

The chat-room management unit 202 transmits instructions to display the chat-room screen to a display terminal of a staff capable of responding to an abnormal event or a sign of an abnormal event represented by input staff-relating data. The displayed chat-room screen is used for a response to the abnormal event or the sign of an abnormal event.

FIG. 4 is a block diagram showing a configuration example of the second exemplary embodiment of the chat-room management unit 202. The chat-room management unit 202 includes a caution/information data analysis unit 212 and a process management unit 222.

The caution/information data analysis unit 212 functions to analyze data to extract a caution or information displayed in the chat-room screen displayed on a display terminal. When data is input from the work/response data extraction unit 201 to the chat-room management unit 202, the caution/information data analysis unit 212 extracts data representing a response to the same type of abnormal event or sign of an abnormal event occurred in the past, from the response-relating data storage unit 207.

Then, the caution/information data analysis unit 212 analyzes the extracted data, and outputs instructions to display a caution or information as a result of the analysis in the chat-room screen, to a display terminal.

The process management unit 222 receives instructions output from the caution/information data analysis unit 212, and transmits the received instructions together with a result of analysis representing a caution or information, to a display terminal. Furthermore, the process management unit 222 receives instructions transmitted from a display terminal to the management device 200.

The report generation unit 203 functions to generate a report. The report generation unit 203 generates a report after all steps of work to be performed is completed.

To generate a report, the report generation unit 203 extracts all data relating to a response about which the report is to be generated, stored in the response-relating data storage unit 207. Furthermore, the report generation unit 203 extracts staff data, process (substep) data, and the like relating to the extracted data.

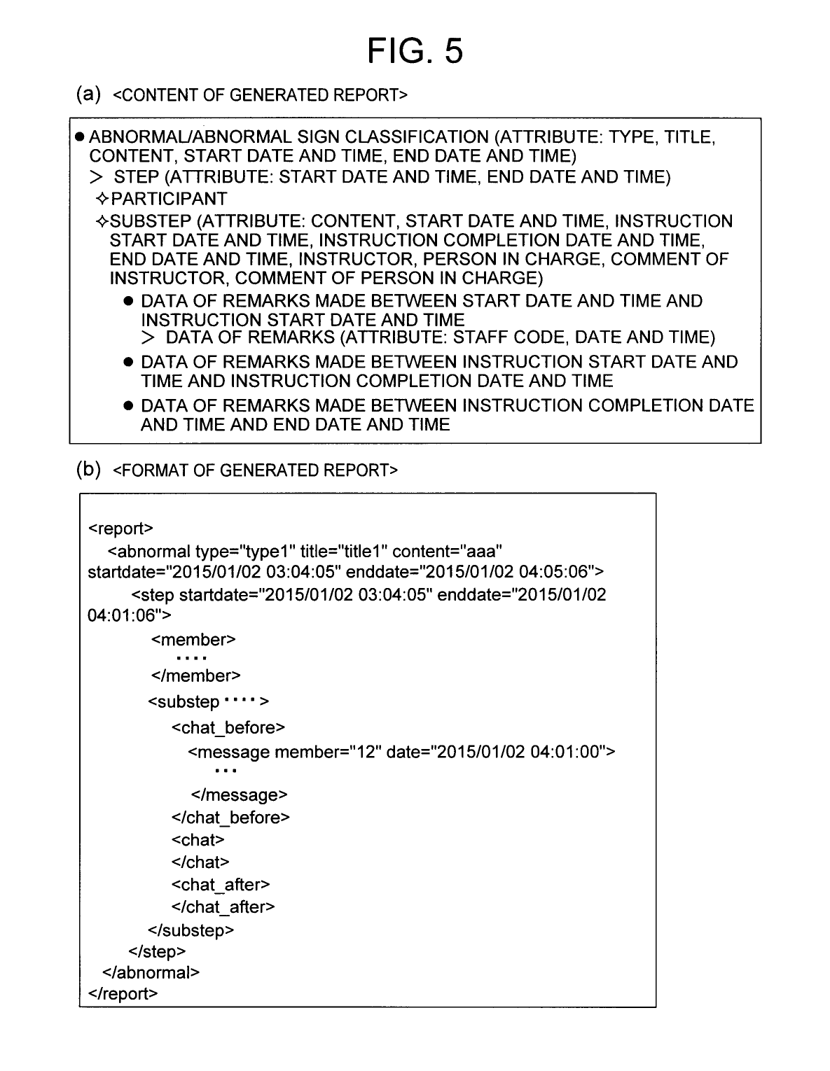

FIG. 5 is an explanatory diagram showing an example of report generated by the report generation unit 203. FIG. 5(a) shows an example of contents of a report generated by the report generation unit 203. Furthermore, FIG. 5(b) shows an example of format of a report generated by the report generation unit 203.

As showed in FIG. 5(b), the report generation unit 203 generates a report in a structured document format, such as hypertext markup language (HTML) or extensible markup language (XML). That is, the report generation unit 203 is configured to output a conversation during a response or a status of instructions, as structured data. The structured data output from the report generation unit 203 uniquely determines a report format, and a response record is recorded in a reusable format.

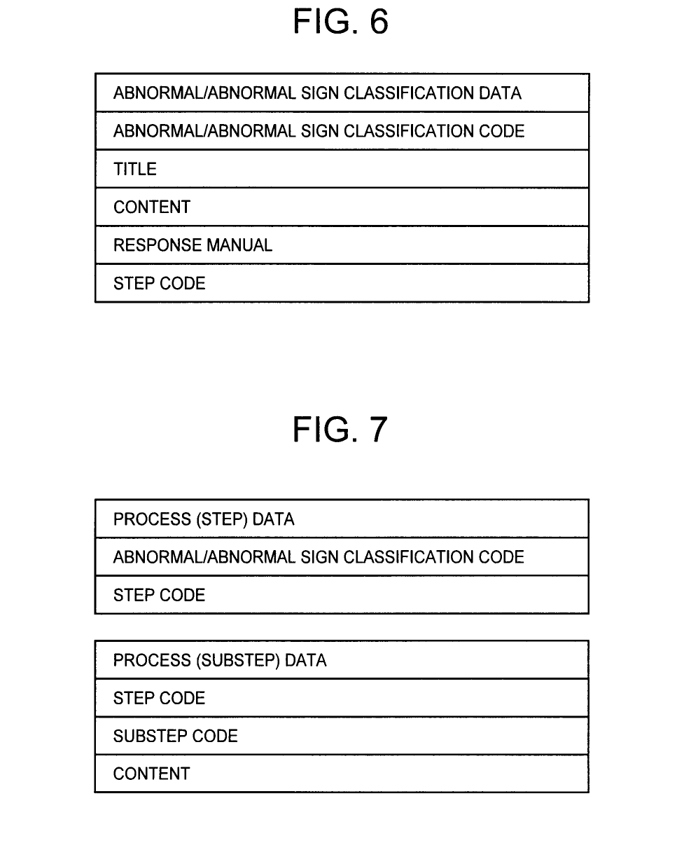

The abnormal/abnormal sign classification-relating data storage unit 204 functions to store the contents of an abnormal event and a sign of an abnormal event, a response manual, and a work code which are associated with each other. FIG. 6 is an explanatory diagram showing an example of abnormal/abnormal sign classification data stored in the abnormal/abnormal sign classification-relating data storage unit 204.

As showed in FIG. 6, the abnormal/abnormal sign classification data includes an abnormal/abnormal sign classification code, a title, a content, a response manual, and a step code. The abnormal/abnormal sign classification code is an identifier of a classification of the abnormal event or a classification of the sign of an abnormal event.

The title is the name of the classification of an abnormal/abnormal sign classification code. The content is the contents of a classification of an abnormal/abnormal sign classification code. The response manual is, for example, a method of making a response to a classification of an abnormal/abnormal sign classification code. The step code is an identifier of a process corresponding to the contents of a response manual.

The process-relating data storage unit 205 functions to store a definition of a process. FIG. 7 is an explanatory diagram showing an example of process (step) data and process (substep) data stored in the process-relating data storage unit 205.

A process includes steps and substeps. The steps have different contents of work and different persons in charge, and each step represents a work unit. Furthermore, each step includes one or a plurality of substeps. Each sub step is obtained by dividing a step and represents a work unit.

As showed in FIG. 7, the process (step) data includes an abnormal/abnormal sign classification code and a step code. That is, one or a plurality of processes (steps) to be performed is associated with a classification of an abnormal event or a classification of a sign of an abnormal event.

Furthermore, as showed in FIG. 7, the process (substep) data includes a step code, a substep code, and a content. That is, one process (step) includes one or a plurality of processes (substeps). Furthermore, the content is a content of a substep indicated by a substep code.

Note that the process (step) data and the process (substep) data are stored, for example, in the process-relating data storage unit 205 in order of use for a response to an abnormal event or a sign of an abnormal event.

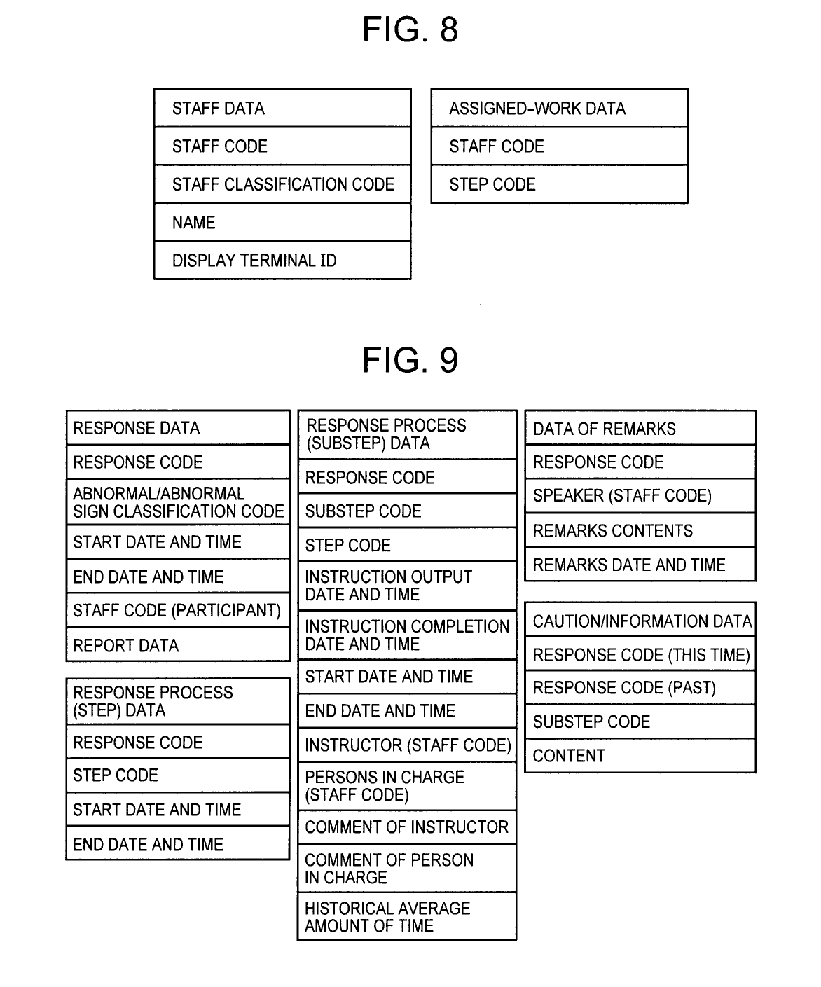

The staff-relating data storage unit 206 functions to store staff-relating information, such as a classification of a staff or an assigned work. FIG. 8 is an explanatory diagram showing an example of staff data and assigned-work data stored in the staff-relating data storage unit 206.

As showed in FIG. 8, the staff data includes a staff code, a staff classification code, a name, and a display terminal ID. The staff code is an identifier of a staff. The staff classification code is a flag indicating whether a staff indicated by a staff code is a worker in the field or the manager in the management center.

The name is a name of a staff indicated by a staff code. The display terminal ID is an identifier of a display terminal of a staff indicated by a staff code. Reference to the staff data allows to identify whether the staff is a worker in the field or the manager in the management center.

Furthermore, as showed in FIG. 8, the assigned-work data includes a staff code and a step code. The step code is an identifier of a step assigned to a staff indicated by a staff code. When assigned-work data is referred to, processes (steps) assigned to staffs are determined.

The response-relating data storage unit 207 functions to store information or the like representing operation performed via the chat-room screen. The response-relating data storage unit 207 stores information representing a past response history, data representing a current response, and the like.

FIG. 9 is an explanatory diagram showing an example of response data, response process (step) data, response process (substep) data, data of remarks, and caution/information data stored in the response-relating data storage unit 207. The data are generated every time of response as described later.

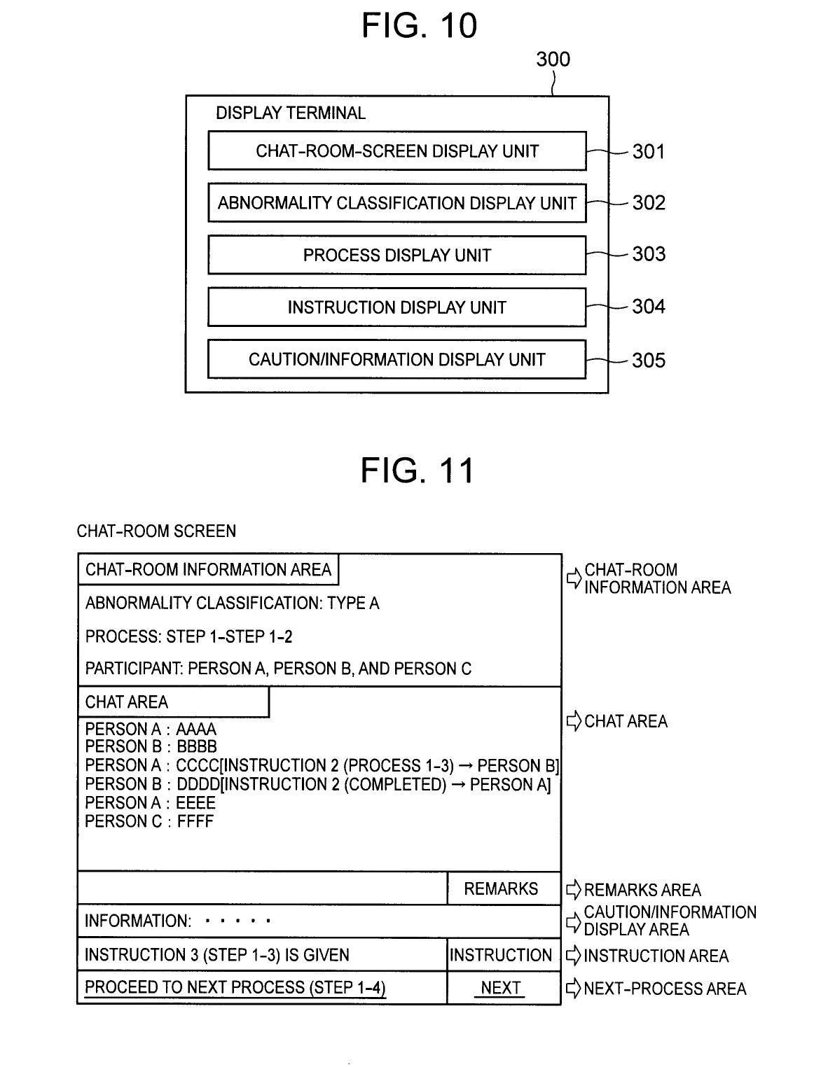

FIG. 10 is a block diagram showing a configuration example of the second exemplary embodiment of the display terminal 300. The display terminal 300 includes a chat-room screen display unit 301, an abnormality classification display unit 302, a process display unit 303, an instruction display unit 304, and a caution/information display unit 305. Note that the configurations of the other display terminals are similar to the configuration showed in FIG. 10.

When the chat-room management unit 202 of the management device 200 transmits instructions to display the chat-room screen to the display terminal 300, the chat-room screen display unit 301 functions to display the chat-room screen. The abnormality classification display unit 302 functions to display the contents of a classification of an abnormal event or the contents of a classification of a sign of an abnormal event in a screen depending on the operation of a terminal owner or the like.

The process display unit 303 functions to display the contents of a process including a response status in a screen depending on the operation of the terminal owner or the like. The instruction display unit 304 functions to display a screen into which information representing instruction output or information representing instruction completion is input, depending on the operation of the terminal owner or the like.

The caution/information display unit 305 functions to display a caution or information in a screen depending on the operation of the terminal owner or the like. All of chats or instructions made via the chat-room screen are recorded in the management device 200. In a case where a past response record to the same type of abnormal event or sign of an abnormal event is used or a past response record in the same substep is used, the caution/information display unit 305 is configured to present a caution or information to the terminal owner as described below.

For example, in a case where the volume of conversation held between the output of instructions and the completion of the instructions is large, the caution/information display unit 305 determines that there is a possibility of occurrence of an event requiring attention during work. In a case where, in the same substep, a situation as described above has occurred in the past, the caution/information display unit 305 displays a message to promote confirmation of the contents of a target chat held between the output of instructions and the completion of the instructions, in the chat-room screen in which a staff being under instructions participates.

Furthermore, for example, in a case where, in comparison between responses in the same substep, a target case taking a longer time from the output of instructions to the completion of the instructions is in the past, the caution/information display unit 305 determines that the target case may have a possibility of occurrence of an event requiring attention, in work in the substep. The caution/information display unit 305 displays a message to promote confirmation of the contents of a target chat held between the output of instructions and the completion of the instructions, in the chat-room screen in which a staff being under instructions participates.

Furthermore, for example, in a case where a time required between the output of instructions and the completion of the instructions, required for a substep in which a response is being made is significantly reduced relative to a time required between the output of instructions and the completion of the instructions, required in the past for the same substep, the caution/information display unit 305 displays a caution in the chat-room screen. For example, the caution/information display unit 305 displays a message promoting confirmation whether there is skipped work or skipped confirmation.

Furthermore, for example, on the basis of a time required between the output of instructions and the completion of the instructions required in the past for the same substep, the caution/information display unit 305 displays a staff who gives instructions to perform estimation of a time required for completion of the instruction and a staff being under instructions, in the chat-room screen.

Furthermore, for example, in a case where a time required for a substep in which a response is being made and in which instructions are not completed is longer than a time required between the output of instructions and the completion of the instructions required in the past for the same substep, the caution/information display unit 305 displays a caution in the chat-room screen. For example, the caution/information display unit 305 displays a message that the manager in the management center should understand a further detailed working status of a worker, in the chat-room screen.

As described above, the caution/information display unit 305 is configured to support a manager and worker in charge of a response to efficiently and correctly perform work.

Hereinafter, the chat-room screen displayed by the chat-room-screen display unit 301 will be described. The chat-room screen displays a classification of an abnormal event or a classification of a sign of an abnormal event. In the chat-room screen, the classification is displayed at a portion as a link.

When the classification as the link is pressed, an abnormal/abnormal sign confirmation screen is displayed. Via the abnormal/abnormal sign confirmation screen, a person in charge is allowed to refer to an overview of an abnormal event or a sign of an abnormal event, a response manual, and past response record to the same type of event. Thus, the person in charge is allowed to effectively confirm or obtain information required for a response.

Furthermore, via the chat-room screen, the person in charge is allowed to give instructions for a target work process. The chat-room screen displays therein a process represented by data extracted before the management device 200 firstly transmits a request to display the chat-room screen.

Instructions as for a target work process can be given by the manager in the management center for each substep. The workers in the field receives instructions given by the manager. The workers can perform work on the basis of the received instructions, for each substep.

As a substep to which instructions are to be given, a substep not completed in a step in which a response is being made is displayed in the chat-room screen of the display terminal of the manager in the management center. The chat-room screen displays an “instruction” button, and when the manager presses the “instruction” button, an instruction screen is displayed.

Furthermore, in the chat-room screen, the process in which a response is being made is displayed at a portion as a link. When the process as the link is pressed, a process list screen is displayed.

FIG. 11 is an explanatory diagram showing an example of chat-room screen displayed by the chat-room-screen display unit 301. As showed in FIG. 11, the chat-room screen includes a chat-room information area, a chat area, a remarks area, a caution/information display area, an instruction area, and a next-process area.

The chat-room information area displays a classification of a current abnormal event or sign of an abnormal event, a process in which a response is being made, and participants in the chat room. Furthermore, in the chat area, a chat conversation between the participants in the chat room is displayed.

Furthermore, the chat area of the chat-room screen displays information about instructions given by the manager. Furthermore, the chat area has a portion indicating issuance of instructions, and the portion displays a tree view of the contents of a chat held between the output of instructions and the completion of the instructions in the same substep upon a response to the same type of abnormal event or sign of an abnormal event occurred in the past.

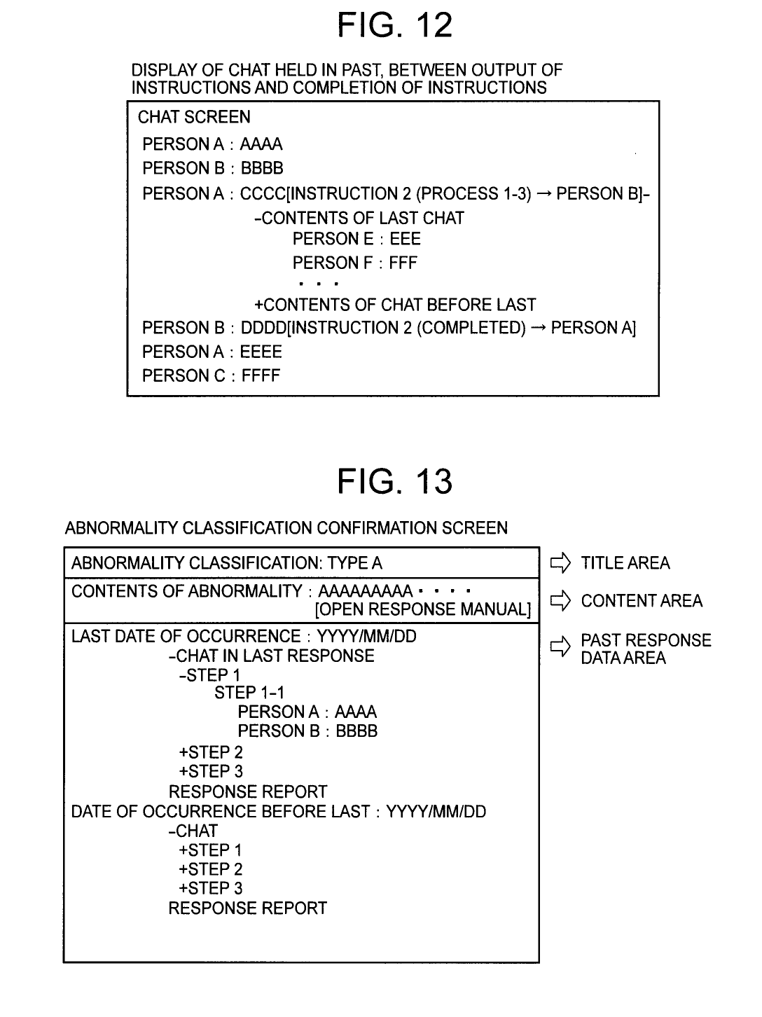

FIG. 12 is an explanatory diagram showing an example of chat in a response given in the past, displayed in the chat area. As showed in FIG. 12, a chat held in the past between the output of instructions and the completion of the instructions is displayed in the chat area. The chat area displays a hierarchical structure of a chat held in the past relating to work for which instructions are given. When a hierarchy is opened, the content of a chat held in the past in the same substep is displayed.

As showed in FIG. 12, since a chat during a response given in the past is displayed in the chat area, workers in the field can find an event requiring attention which has occurred in a response given in the past or avoid giving a wrong response.

The remarks area is an area in which a terminal owner inputs text remarks in a chat. After the text remarks are input, the terminal owner presses a right “remarks” button, and the contents of text remarks input to the chat area is displayed.

The caution/information display area displays, for example, a caution or information transmitted from the chat-room management unit 202. The instruction area is an area used by the terminal owner to give instructions, confirms the instructions, and complete the instructions. Pressing the right “instruction” button enables the terminal owner to, for example, give new instructions.

The next-process area is an area used by the terminal owner to progress a process in which a response is being made to a next process. For example, as showed in FIG. 11, when the terminal owner presses a right “next” button while the next-process area displays “proceed to the next process (step 1-4)”, the process in which a response is being made proceeds to “step 1-4”.

Note that, in an example showed in FIG. 11, “proceed to the next process (step 1-4)” and “next” are displayed underlined. That is, in a step showed in FIG. 11, the process cannot proceeds to “step 1-4”. In the above description, the terminal owner cannot press the “next” button. In a step in which the process can proceed to “step 1-4”, the displayed underlines are removed, and the terminal owner can press the “next” button.

In the chat-room information area of the chat-room screen, an abnormality classification is displayed at a portion as a link. When the terminal owner presses the link of the abnormality classification, the abnormality classification display unit 302 displays an abnormality classification confirmation screen.

FIG. 13 is an explanatory diagram showing an example of abnormality classification confirmation screen displayed by the abnormality classification display unit 302. As showed in FIG. 13, the abnormality classification confirmation screen includes a title area, a content area, and a past response data area.

As showed in FIG. 13, the title area displays the name of the classification of an abnormal event or the classification of a sign of an abnormal event.

Furthermore, as showed in FIG. 13, the content area displays the contents of the classification of the name displayed in the title area. Furthermore, in the content area, a link, described as “[open response manual]”, is also displayed. When the terminal owner presses the displayed link, a response manual corresponding to the classification of the name displayed in the title area is displayed.

Furthermore, as showed in FIG. 13, the past response data area displays past response data corresponding to the classification of the name displayed in the title area. The displayed past response data is, for example, the contents of a chat held in the past, as showed in FIG. 13.

In the chat-room information area of the chat-room screen, a process is displayed at a portion as a link. When the terminal owner presses the link of the process, the process display unit 303 displays the process list screen.

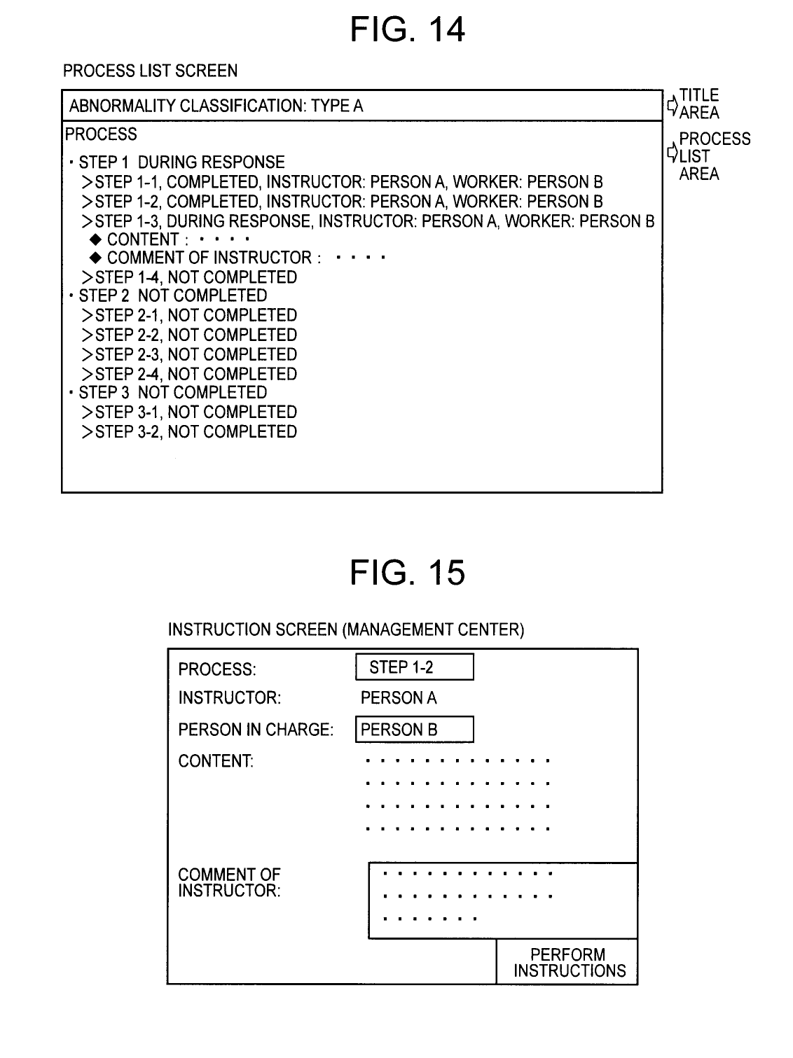

FIG. 14 is an explanatory diagram showing an example of process list screen displayed by the process display unit 303. As showed in FIG. 14, the process list screen includes a title area and a process list area.

As showed in FIG. 14, the title area displays the name of the classification of an abnormal event or the classification of a sign of an abnormal event.

Furthermore, in the process list area, a list of processes corresponding to the classification of the name displayed in the title area is displayed. Specifically, as showed in FIG. 14, the process list area displays a tree view of steps and substeps.

In the process list area, for example, a process status displayed currently in the chat-room screen is displayed. The displayed process status includes an instruction status, an instructor, a person in charge who receives instructions, the contents of the instructions, a comment of the instructor, a comment of a person in charge, and the like. That is, the process list area displays a performance status and performance contents in a substep.

In the instruction area of the chat-room screen, predetermined information is displayed by the instruction display unit 304. Furthermore, the instruction display unit 304 displays an instruction screen for the manager and an instruction screen for workers respectively.

FIG. 15 is an explanatory diagram showing an example of instruction screen displayed by the instruction display unit 304. The instruction screen showed in FIG. 15 is an instruction screen displayed on the display terminal of the manager in the management center. To make new instructions, in the instruction area in the chat-room screen displayed on the display terminals of the manager, the manager presses the “instruction” button, and the instruction display unit 304 displays the instruction screen showed in FIG. 15.

Via the instruction screen showed in FIG. 15, the manager is allowed to select a process (substep) to which instructions are given to perform work. For the contents of the instruction screen, the contents of the selected substep are displayed. Furthermore, via the instruction screen showed in FIG. 15, the manager is allowed to select a person in charge as a person to be instructed. Furthermore, the manager is allowed to input a comment from the instructor in the instruction screen showed in FIG. 15.

When the manager presses a “perform instructions” button positioned at a bottom right portion in the screen after specifying all information, performance of the selected substep is displayed as instruction contents in the instruction area of the chat-room screen displayed on a display terminal of a selected person in charge. That is, via the instruction screen showed in FIG. 15, the manager is allowed to select a person in charge and give instructions to the selected person in charge.

As described above, the manager in the management center is allowed to select a worker in the field to be in charge of work of a displayed substep, input a comment to the selected worker, giving instructions. When the manager gives instructions, issuance of the instructions is displayed in the chat-room screen displayed on a display terminal of the worker in the field being in charge of work of the substep for which instructions are given.

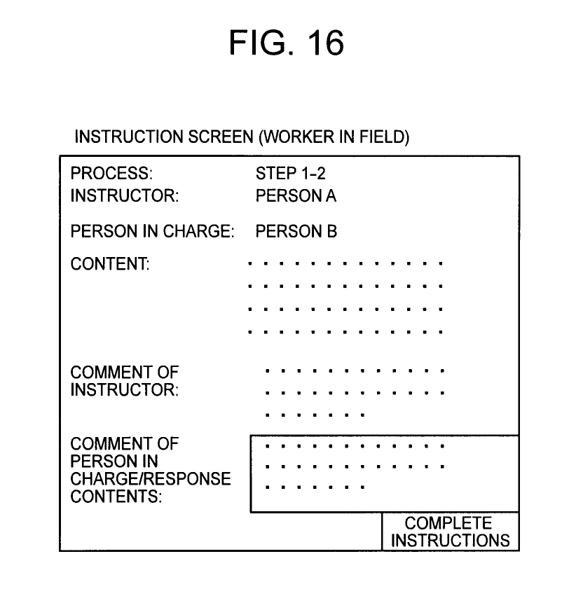

FIG. 16 is an explanatory diagram showing another example of instruction screen displayed by the instruction display unit 304. The instruction screen showed in FIG. 16 is an instruction screen displayed on a display terminal of a worker in the field. To confirm instructions or complete instructions, in the chat-room screen displayed on the display terminal of the worker, the worker presses the “instruction” button in the instruction area, and the instruction display unit 304 displays the instruction screen showed in FIG. 16.

As showed in FIG. 16, the instruction screen displays the instructor, the person in charge, the contents of the substep for which instructions are given, and a comment of the instructor. The person in charge who is under instructions is allowed to confirm the instructions or complete the instructions via the instruction screen showed in FIG. 16.

To complete the instructions, the person in charge inputs a comment of the person in charge into the instruction screen showed in FIG. 16, and presses “complete instructions” button at a bottom right portion in the screen. Pressing the “complete instructions” button enables the person in charge to complete the instructions.

As described above, when a worker in the field presses the “instruction” button, the instruction screen enabling confirmation of the contents of given instructions (i.e., a substep and the contents of work) and a comment from the instructor is displayed. After work, the worker in the field who is under instructions is allowed to input a response content into the instruction screen, press the “complete instructions” button, and complete the instructions.

After completion of the instructions, a next substep to which instructions are to be given is displayed in the chat-room screen of the display terminal of the manager in the management center. The manager repeatedly gives instructions until all substeps are completed.

Issuance of instructions and completion of the instructions are displayed in the chat area of the chat-room screen. Furthermore, issuance of instructions and completion of the instructions are recorded in the management device 200. Owing to the above configuration, work is performed while transmitting information between the manager and a worker without interruption, and the possibility of skipped work is reduced.

### Description of Operation

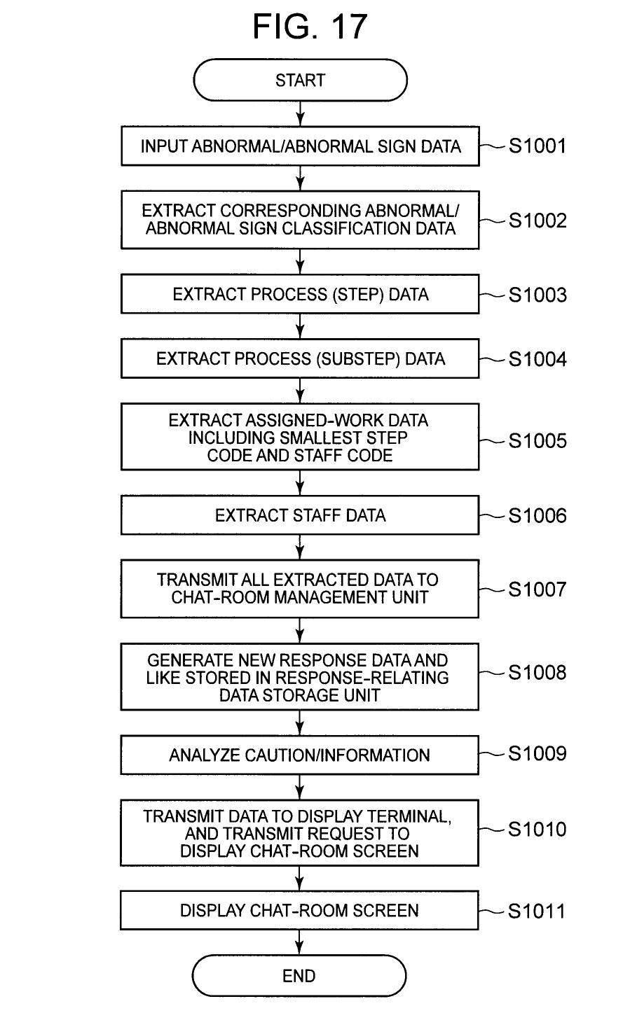

Hereinafter, operation of the process management system 100 according to the present exemplary embodiment will be described with reference to FIGS. 17 to 24, FIG. 26, and FIGS. 29 to 30.

Firstly, a process from input of abnormal/abnormal sign data into the management device 200 to display of the chat-room screen on the display terminals of staffs will be described. FIG. 17 is a flowchart showing an operation of a chat-room screen display processing by the process management system 100 according to the second exemplary embodiment.

An abnormal/abnormal sign data is input into the work/response data extraction unit 201 of the management device 200 (step S1001). The work/response data extraction unit 201 extracts abnormal/abnormal sign classification data, which includes an abnormal/abnormal sign classification code included in the input abnormal/abnormal sign data, from the abnormal/abnormal sign classification-relating data storage unit 204 (step S1002).

Then, the work/response data extraction unit 201 extracts process (step) data, which includes an abnormal/abnormal sign classification code included in the extracted abnormal/abnormal sign classification data, from the process-relating data storage unit 205 (step S1003).

Then, the work/response data extraction unit 201 extracts process (substep) data, which includes a step code included in the extracted process (step) data, from the process-relating data storage unit 205 (step S1004). During the step up to step S1005, information, such as the contents of the classification of an abnormal event or a sign of an abnormal event, and a process (step and substep) corresponding to the classification are obtained.

As showed in FIG. 8, a step code and a staff code of a person in charge are associated with each other. The work/response data extraction unit 201 identifies a step in which work is firstly performed with respect to an occurred abnormal event or sign of an abnormal event.

The first step is a step indicated by a smallest step code of step codes included in the extracted process (step) data. The work/response data extraction unit 201 confirms a corresponding step code, and extracts the assigned-work data including the confirmed step code, from the staff-relating data storage unit 206 (step S1005).

Next, the work/response data extraction unit 201 confirms a staff code included in the extracted assigned-work data, and extracts staff data including the confirmed staff code from the staff-relating data storage unit 206 (step S1006). A staff indicated by the staff data extracted in step S1006 is a staff who performs the first step.

Then, the work/response data extraction unit 201 transmits all data extracted before step S1006 to the chat-room management unit 202 (step S1007). After the data is transmitted, the chat-room management unit 202 generates new response data, response process (step) data, and response process (substep) data, which are stored in the response-relating data storage unit 207 for a response made this time respectively (step S1008).

Firstly, the chat-room management unit 202 generates response data. A response code of the response data is automatically numbered upon generation of the response data. Furthermore, the chat-room management unit 202 stores an abnormal/abnormal sign classification code included in the transmitted data, for the abnormal/abnormal sign classification code of the response data. Furthermore, the chat-room management unit 202 stores current date and time, for start date and time of the response data.

Similarly, the chat-room management unit 202 generates the response process (step) data, on the basis of the transmitted process (step) data. The chat-room management unit 202 stores current date and time only for the start date and time of response process (step) data, generated on the basis of process (step) data having a minimum step code, of the generated response process (step) data. The chat-room management unit 202 stores no value for the other generated response process (step) data.

Similarly, the chat-room management unit 202 generates the response process (substep) data on the basis of the transmitted process (substep) data.

Then, the chat-room management unit 202 refers to the abnormal/abnormal sign classification code included in the transmitted data to extract, from the response-relating data storage unit 207, data corresponding to the abnormal/abnormal sign classification code referred to.

Then, the caution/information data analysis unit 212 of the chat-room management unit 202 analyzes the extracted data as described later so that a caution or information is displayed on the chat-room screen (step S1009).

Then, the chat-room management unit 202 refers to a display terminal ID included in the transmitted staff data, and requires a display terminal indicated by the display terminal ID referred to to display the chat-room screen. Furthermore, the chat-room management unit 202 transmits the transmitted data, the generated response data, the generated response process (step) data, the generated response process (substep) data, past response data, and the like to a display terminal indicated by the display terminal ID (step S1010).

The display terminal receiving the request to display the chat-room screen displays the chat-room screen, on the basis of the received data (step S1011). The chat-room-screen display unit 301 displays a title included in the received abnormal/abnormal sign classification data, in the chat-room information area of the chat-room screen.

Furthermore, in the chat-room information area, the chat-room-screen display unit 301 displays, as a process (step) in which a response is being made, a process (step) indicated by a smallest step code of step codes included in the response process (step) data having no value stored for end date and time.

Furthermore, the chat-room-screen display unit 301 displays, as a process (substep) in which a response is being made, a process (substep) indicated by a smallest substep code of substep codes included in the response process (substep) data including the step code indicating the displayed step, and having no value stored for end date and time.

That is, in the chat-room information area, the chat-room-screen display unit 301 displays a step and a substep identified as described above, as the process in which a response is being made. Furthermore, in the chat-room information area, the chat-room-screen display unit 301 displays, as a participant, a name included in the received staff data. After displaying the chat-room screen including the respective information as described above, the process management system 100 finishes the chat-room screen display processing.

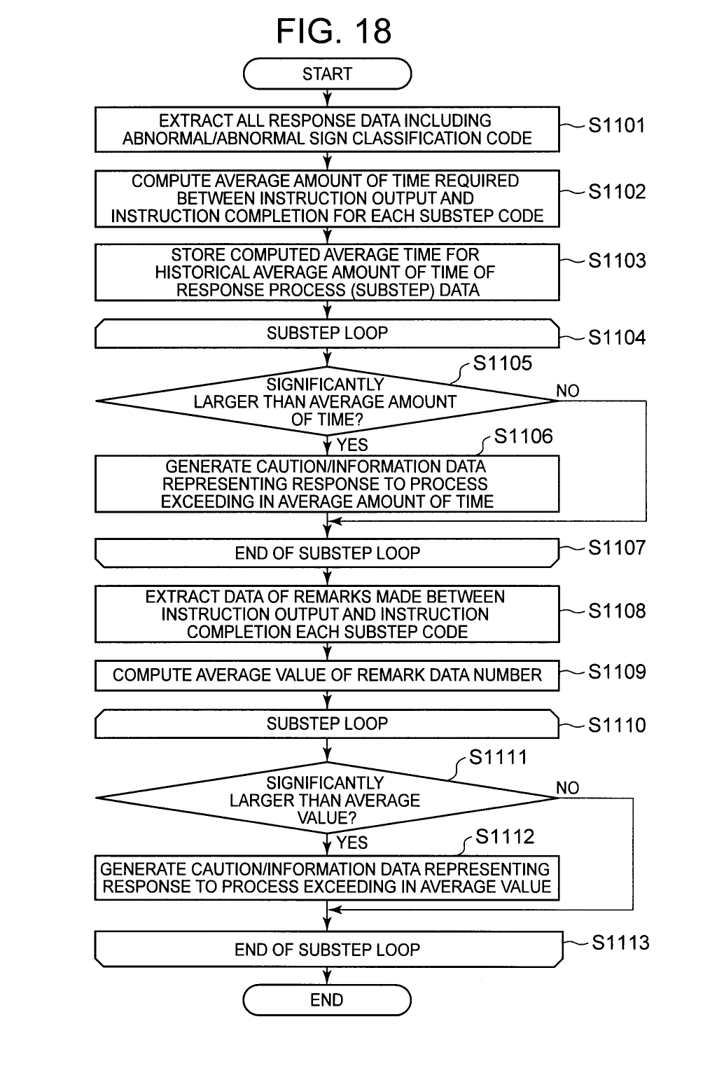

Next, the process of step S1009 will be described in which the caution/information data analysis unit 212 analyzes data so that a caution or information is displayed in the chat-room screen. FIG. 18 is a flowchart showing an operation of data analysis processing by the caution/information data analysis unit 212 according to the second exemplary embodiment.

The data transmitted to the chat-room management unit 202 is input into the caution/information data analysis unit 212. The caution/information data analysis unit 212 refers to the abnormal/abnormal sign classification code included in the input abnormal/abnormal sign classification data to extract response data including the code referred to from the response-relating data storage unit 207.

Furthermore, the caution/information data analysis unit 212 extracts all data including a response code included in the extracted response data from the response-relating data storage unit 207 (step S1101). However, the data generated in step S1008 are excluded from objects to be extracted. In step S1101, response data including the same abnormal/abnormal sign classification code are extracted from the response-relating data storage unit 207.

Then, the caution/information data analysis unit 212 computes an average amount of time between instruction output date and time and instruction completion date and time, on the basis of past response process (substep) data, for each substep code (step S1102). After computation, the caution/information data analysis unit 212 stores the computed average amount of time for a historical average amount of time of the response process (substep) data generated in step S1008 (step S1103).

Then, the caution/information data analysis unit 212 confirms past response process (substep) data, for each substep code. That is, the caution/information data analysis unit 212 enters a substep loop (step S1104).

The caution/information data analysis unit 212 confirms whether there is past response process (substep) data having a processing time significantly larger than the computed average amount of time (step S1105). In a case where there is past response process (substep) data having a processing time significantly larger than the average amount of time (Yes in step S1105), the caution/information data analysis unit 212 generates new caution/information data (step S1106).

The generated new caution/information data stores a response code generated this time as a “response code (this time)”, a response code having a processing time exceeding the average amount of time as a “response code (past)”, and a substep code as a “substep code”. Furthermore, a response having a processing time significantly exceeding the average amount of time is stored as a “content”.

The caution/information data analysis unit 212 determines whether a processing time significantly exceeds the average amount of time, on the basis of, for example, a predetermined threshold value. For example, in a case where a processing time exceeds 150% of the average amount of time, the caution/information data analysis unit 212 determines that the processing time significantly exceeds the average amount of time. The generated caution/information data is stored in the response-relating data storage unit 207.

While there is an unanalyzed substep, the process of steps S1105 to S1106 are repeatedly performed. The process of steps S1105 to S1106 is repeatedly performed for unanalyzed substeps a number of times equal to the number of the substeps. All of the substeps are analyzed, the caution/information data analysis unit 212 exits the substep loop (step S1107).

Then, the caution/information data analysis unit 212 extracts data of remarks made between instruction output date and time and instruction completion date and time, from the past response process (substep) data, from each substep code (step S1108). Then, the caution/information data analysis unit 212 computes an average value of the number of extracted data of remarks, for each substep code (step S1109).

Then, the caution/information data analysis unit 212 confirms past response process (substep) data, for each substep code. That is, the caution/information data analysis unit 212 enters a substep loop (step S1110).

The caution/information data analysis unit 212 confirms whether there is past response process (substep) data having a number of data of remarks significantly exceeding the computed average value (step S1111). In a case where there is past response process (substep) data having a number of data of remarks significantly exceeding the average value (Yes in step S1111), the caution/information data analysis unit 212 generates new caution/information data (step S1112).

The generated new caution/information data stores a response code generated this time as a “response code (this time)”, a response code having a number of data of remarks exceeding the average value as a “response code (past)”, and a substep code as a “substep code”. Furthermore, a response having a number of data of remarks significantly exceeding the average time is stored as a “content”. The generated caution/information data is stored in the response-relating data storage unit 207.

While there is an unanalyzed substep, the process of steps S1111 to S1112 are repeatedly performed. The process of steps S1111 to S1112 is repeatedly performed for unanalyzed substeps a number of times equal to the number of the substeps. After all of the substeps are analyzed, the caution/information data analysis unit 212 exits the substep loop (step S1113), and finishes the data analysis processing.

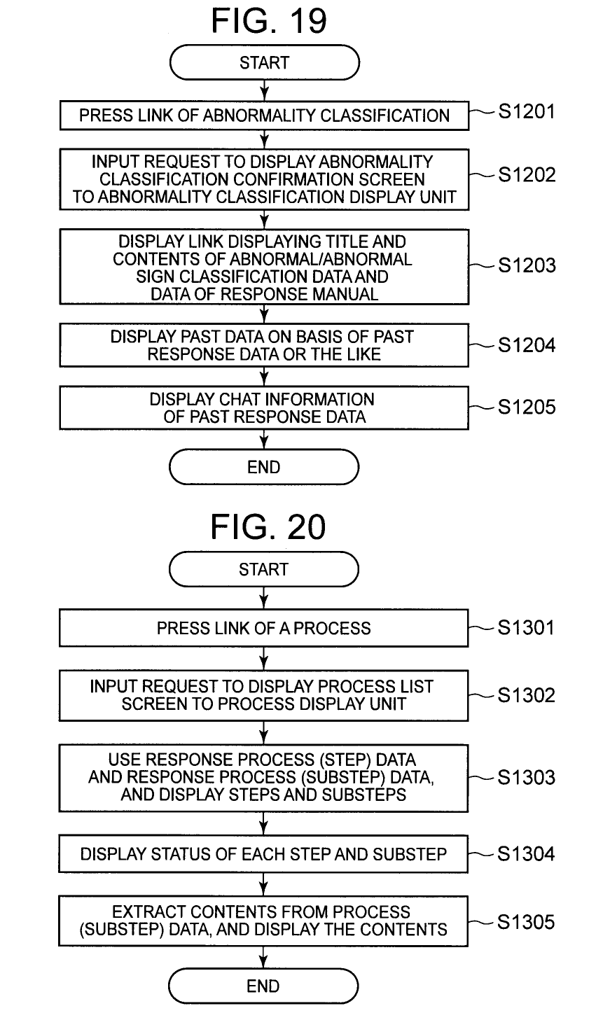

Next, a process for displaying the abnormality classification confirmation screen by the abnormality classification display unit 302 will be described. FIG. 19 is a flowchart showing an operation of an abnormality classification confirmation screen display processing by the abnormality classification display unit 302 according to the second exemplary embodiment.

In the chat-room information area of the chat-room screen, an abnormality classification is displayed at a portion as a link. When a terminal owner presses the link of the abnormality classification (step S1201), a request to display the abnormality classification confirmation screen is input to the abnormality classification display unit 302 of the display terminal (step S1202).

The abnormality classification display unit 302 receiving the input of the display request displays the abnormality classification confirmation screen. Then, the abnormality classification display unit 302 extracts stored abnormal/abnormal sign classification data, and displays a title included in the abnormal/abnormal sign classification data in the title area, and the contents included therein in the content area. Furthermore, the abnormality classification display unit 302 displays a link pressed and displaying data of a response manual in the content area (step S1203).

Then, the abnormality classification display unit 302 displays past data in the past response data area, on the basis of stored past response data or the like (step S1204). For example, in the displayed past data, the abnormality classification display unit 302 displays start date and time of the past response data as past response date (e.g., “last date of occurrence” in FIG. 13)

Then, in the past response data area, the abnormality classification display unit 302 displays data of remarks made from start date and time of the past response data, as chat information (step S1205).

The abnormality classification display unit 302 uses information about start date and time and information about end date and time which are included in response process (step) data and response process (substep) data to sort data of remarks in accordance with step and substep, and displays the sorted data of remarks. After display, the abnormality classification display unit 302 finishes the abnormality classification confirmation screen display processing.

Next, a process of displaying the process list screen by the process display unit 303. FIG. 20 is a flowchart showing an operation of a process list screen display processing by the process display unit 303 according to the second exemplary embodiment.

In the chat-room information area of the chat-room screen, a process is displayed at a portion as a link. When a terminal owner presses the link of a process (step S1301), a request to display the process list screen is input to the process display unit 303 of the display terminal (step S1302).

The process display unit 303 receiving the input of the display request displays the process list screen. Then, the process display unit 303 displays the process (steps and substeps) in this time in the process list area.

In display, the process display unit 303 uses the response process (step) data and the response process (substep) data generated in step S1008 to display a tree view of steps and substeps as showed in FIG. 14. Furthermore, the process display unit 303 displays steps in ascending order of step code. Furthermore, the process display unit 303 displays substeps in each step in ascending order of substep code (step S1303).

Then, the process display unit 303 displays the status of each step and substep (step S1304). The process display unit 303 displays the status of each step and substep as “not completed”, “completed”, or “during response”.

Response process data having a value stored for start date and time and having no value stored for end date and time corresponds to “during response”. Response process data having no value stored for start date and time and end date and time corresponds to “not completed”.

Response process data having a value stored for end date and time corresponds to “completed”. Note that, in a case where, in a substep, response process (substep) data has values stored for the instructor and the person in charge, the process display unit 303 displays the stored values.

Then, the process display unit 303 displays, under a substep, the contents of the substep, and a comment of the instructor and the comment of a person in charge in this response. The process display unit 303 extracts the contents from the process (substep) data including a substep code of the response process (substep) data, and displays, under the substep, the contents as the contents of the substep.

Furthermore, the process display unit 303 extracts the comment of the instructor and the comment of the person in charge from the response process (substep) data, and displays the comments, under the substep (step S1305). After display, the process display unit 303 finishes the process list screen display processing.

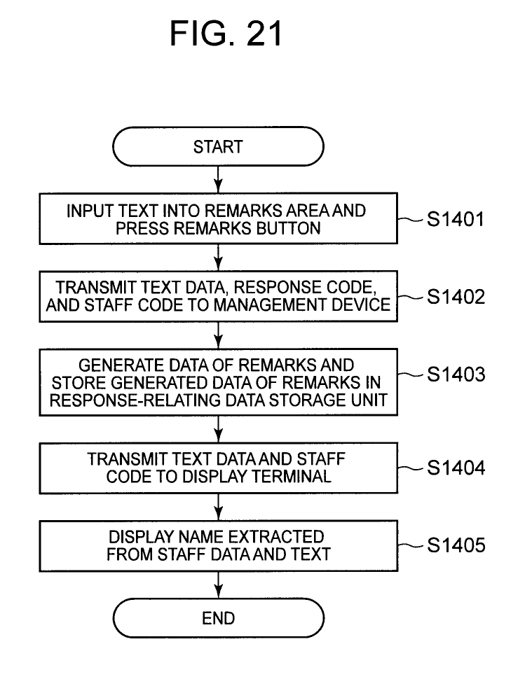

Next, a process of conversation held in the chat-room screen will be described. FIG. 21 is a flowchart showing an operation of conversation processing by the process management system 100 according to the second exemplary embodiment.

A participant in the chat room inputs a text into the remarks area of the chat-room screen, and presses the “remarks” button (step S1401). The chat-room-screen display unit 301 transmits the input text data, a response code, and a staff code of a staff having the display terminal of his/her own to the chat-room management unit 202 of the management device 200 (step S1402).

Then, the chat-room management unit 202 generates data of remarks as showed in FIG. 9, with the received text data as “remarks contents”, the staff indicated by the received staff code as “speaker”, the received response code as “response code”, and reception date and time as “remarks date and time”. The chat-room management unit 202 stores the generated data of remarks in the response-relating data storage unit 207 (step S1403).

Then, the management device 200 transmits the received text data and staff code to a display terminal (step S1404).

Then, the chat-room-screen display unit 301 of the display terminal receives the transmitted data. The chat-room-screen display unit 301 extracts a name corresponding to the received staff code, from the stored staff data.

Then, the chat-room-screen display unit 301 displays, as part of conversation, the received text data in the chat area together with the extracted name (step S1405). After display, the process management system 100 finishes the conversation processing.

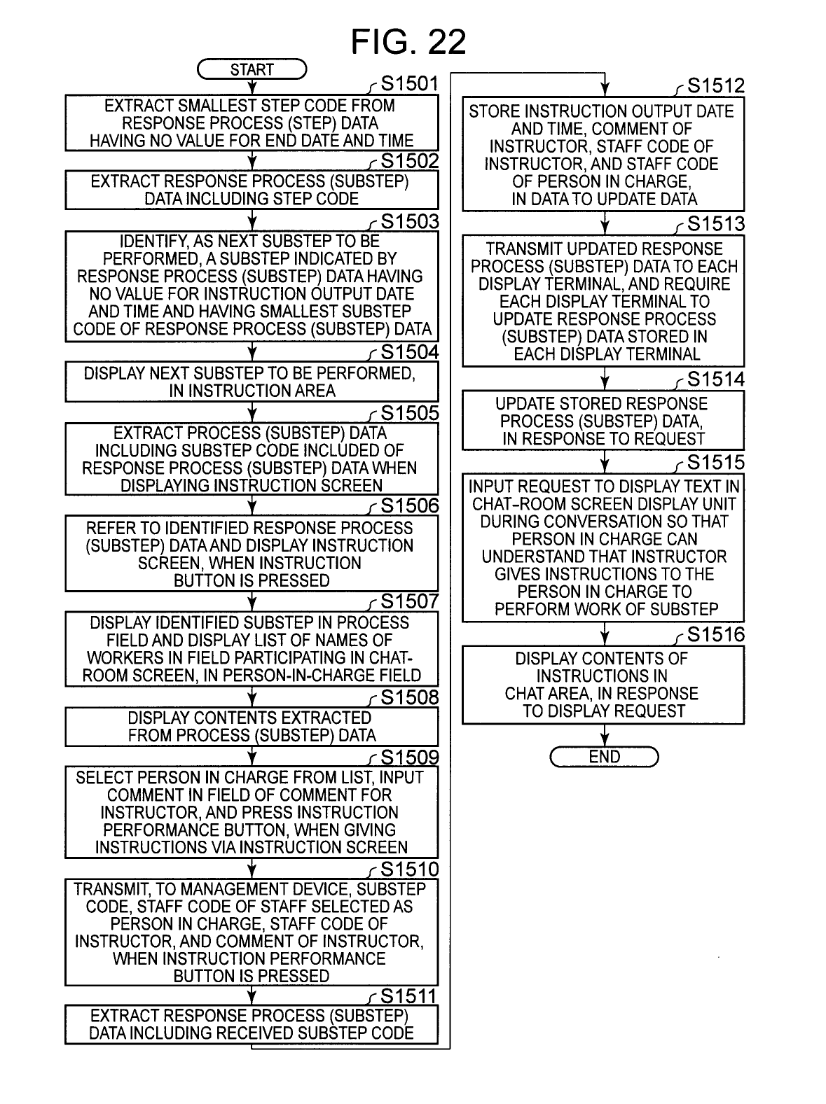

Next, a process of displaying the instruction screen by operation of the manager in the management center, and an instruction process via the instruction screen will be described. FIG. 22 is a flowchart showing an operation of instruction processing by the process management system 100 according to the second exemplary embodiment.

The instruction display unit 304 inputs a display request to the chat-room screen display unit 301, and in the instruction area displayed on the display terminal of the manager in the management center, a message promoting output of instructions to perform a next substep for which work is to be performed is displayed.

To specify a next substep for which work is to be performed, the instruction display unit 304 extracts a smallest step code from step codes included in the response process (step) data having no value stored for the end date and time (step S1501).

Then, the instruction display unit 304 extracts response process (substep) data including the extracted step code (step S1502).

Then, the instruction display unit 304 identifies, as the next substep for which work is to be performed, a substep indicated by response process (substep) data having no value stored for the instruction output date and time and having the smallest substep code of the extracted response process (substep) data (step S1503).

Then, the instruction display unit 304 uses the substep code indicating the next substep for which work is to be performed and the step code, and requires the chat-room screen display unit 301 to display the next substep for which work is to be performed, in the instruction area. On the basis of the request, the chat-room screen display unit 301 displays the next substep for which work is to be performed, in the instruction area (step S1504).

Then, when the manager presses the “instruction” button, the chat-room screen display unit 301 inputs a request to display the instruction screen, to the instruction display unit 304. To display the instruction screen, the instruction display unit 304 extracts process (substep) data including a substep code included in the response process (substep) data (step S1505). Referring to the response process (substep) data relating to the identified substep, the instruction display unit 304 displays the instruction screen as showed in FIG. 15 (step S1506).

The instruction display unit 304 displays the identified substep in a process field in the instruction screen. Furthermore, in a person-in-charge field in the instruction screen, the instruction display unit 304 displays a list of the names of workers in the field participating in the chat room (step S1507). Furthermore, in a content field in the instruction screen, the instruction display unit 304 displays the contents extracted from the process (substep) data (step S1508).

Then, when giving instructions via the instruction screen, the manager selects a person in charge who receives instructions, from the displayed list of workers, inputs a comment in a field of a comment for an instructor, and presses the “perform instructions” button (step S1509).

When the “perform instructions” button is pressed, the instruction display unit 304 transmits, to the management device 200, the sub step code, a staff code indicating a staff selected as the person in charge, a staff code indicating the instructor, and the comment of the instructor. These data received by the management device 200 is input to the process management unit 222 of the chat-room management unit 202 (step S1510).

Then, the process management unit 222 extracts response process (substep) data including the input substep code from the response-relating data storage unit 207 (step S1511).

Then, the process management unit 222 stores instruction output date and time, the comment of the instructor, the staff code indicating the instructor, and the staff code indicating the person in charge, in the extracted response process (substep) data to update the data (step S1512). For the instruction output date and time, for example, date and time at which the management device 200 receives the data is stored.

Then, the process management unit 222 transmits the updated response process (substep) data to each display terminal. By transmission of the updated response process (substep) data, the process management unit 222 requires each display terminal to update response process (substep) data stored in each display terminal (step S1513).

The updated data received by the display terminal is input into the process display unit 303. The process display unit 303 receiving the input of the updated data updates the response process (substep) data stored in the display terminal to the input data (step S1514).

Furthermore, the instruction display unit 304 requires the chat-room screen display unit 301 to display a text in the chat area so that during a conversation a person in charge can understand that the instructor gives instructions to the person in charge to perform work of the substep (step S1515). The chat-room screen display unit 301 receives the request from the instruction display unit 304, and displays the contents of output of the instructions in the chat area (step S1516). After display, the process management system 100 finishes the instruction processing.

Note that in the chat area, the contents of output of the instructions is displayed at a portion as a link. When the link of the contents of output of the instructions is pressed, a tree view of a conversation history of a response to the same type of abnormal event or sign of an abnormal event occurred in the past is displayed as showed in FIG. 12. When the link is pressed, the process display unit 303 refers to a past response process (substep) data including the same substep code, extracting data of remarks held between instruction output date and time and instruction completion date and time, displaying a conversation history.

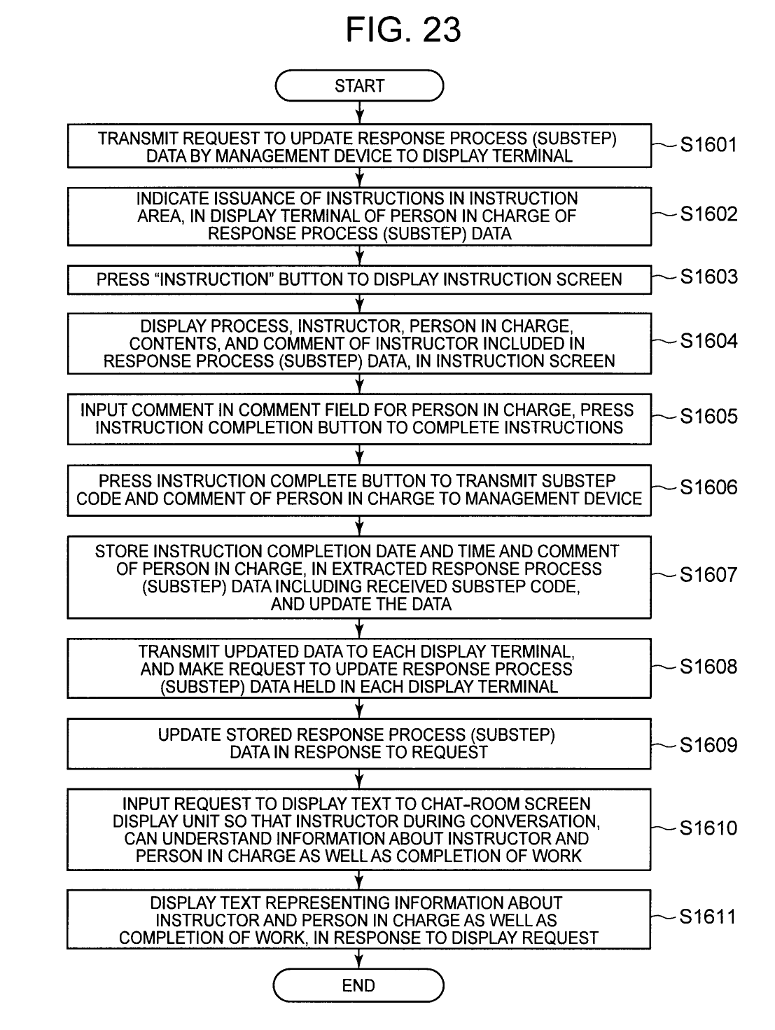

Next, a process of displaying instructions in the instruction area in the chat-room screen of a display terminal of a worker in the field, and a process of completion of instructions by operation of a worker. FIG. 23 is a flowchart showing an operation of another instruction processing by the process management system 100 according to the second exemplary embodiment.

When the manager in the management center gives instructions, a request to update response process (substep) data is transmitted from the management device 200 to a display terminal (step S1601). The update request received by the display terminal is input to the instruction display unit 304.

In a case where the worker's display terminal is a display terminal of a person in charge included in the response process (substep) data, the instruction display unit 304 to which the update request is input requires the chat-room screen display unit 301 to display issuance of the instructions in the instruction area. The required chat-room screen display unit 301 displays the issuance of the instructions in the instruction area (step S1602).

Then, when the worker presses the “instruction” button, the chat-room screen display unit 301 inputs a request to display the instruction screen, to the instruction display unit 304. The instruction display unit 304 receiving the input of the display request displays the instruction screen (step S1603).

On the basis of the response process (substep) data, the instruction display unit 304 displays the instruction screen, as showed in FIG. 16. The instruction display unit 304 displays a process included in the response process (substep) data, an instructor, a person in charge, and the contents included in the process (substep) data, and a comment of the instructor, in the instruction screen (step S1604).

Furthermore, as showed in FIG. 16, the instruction screen is provided with a comment field for the person in charge. The person in charge inputs a comment in the comment field for the person in charge, presses the “complete instructions” button, and the instructions are completed (step S1605). When the “complete instructions” button is pressed, the instruction display unit 304 transmits a substep code and the comment of the person in charge included in the instruction screen to the management device 200 (step S1606).

These data received by the management device 200 is input to the process management unit 222 of the chat-room management unit 202. The process management unit 222 extracts the response process (substep) data including the input substep code from the response-relating data storage unit 207.

Then, the process management unit 222 stores instruction completion date and time and the comment of the person in charge in the extracted response process (substep) data, and updates the data (step S1607). For the instruction completion date and time, for example, date and time at which the management device 200 receives the data is stored.

Then, the process management unit 222 transmits the updated response process (substep) data to each display terminal. By transmission of the updated response process (substep) data, the process management unit 222 requires each display terminal to update the response process (substep) data stored in each display terminal (step S1608).

The updated data received by the display terminal is input into the process display unit 303. The process display unit 303 receiving the input of the updated data updates the response process (substep) data stored in the display terminal to the input data (step S1609).

Furthermore, the instruction display unit 304 requires the chat-room screen display unit 301 to display a text in the chat area so that the instructor during a conversation can understand information about the instructor and the person in charge as well as completion of work (step S1610). The chat-room screen display unit 301 receives the request from the instruction display unit 304, and displays the contents of completion of the instructions in the chat area (step S1611). After display, the process management system 100 finishes the instruction processing.

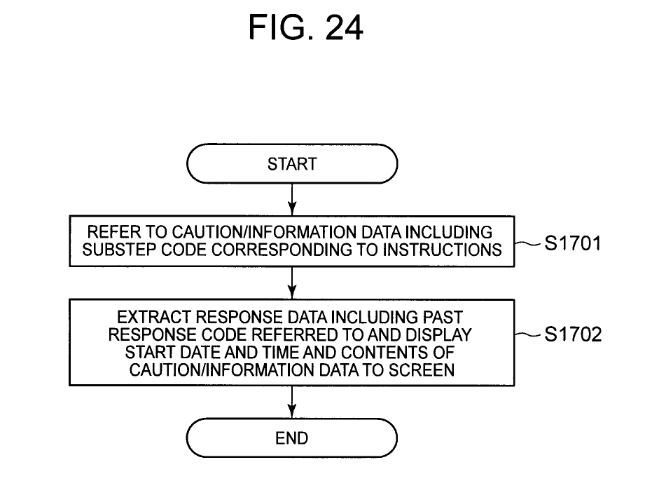

Next, a process of displaying a caution or information in the caution/information display area by the caution/information display unit 305. FIG. 24 is a flowchart showing an operation of caution/information display processing by the caution/information display unit 305 according to the second exemplary embodiment.

When instructions are output, the caution/information display unit 305 refers to caution/information data including a substep code corresponding to the output instructions (step S1701). The caution/information display unit 305 extracts response data including a past response code included in the caution/information data referred to, from the response-relating data storage unit 207.

Then, the caution/information display unit 305 inputs a request to display start date and time included in the extracted response data and contents included in the caution/information data to the chat-room-screen display unit 301. The chat-room-screen display unit 301 displays these information in the caution/information display area (step S1702). These information are displayed in the caution/information display area, and the contents of a response which may have a problem are referred to. After display, the caution/information display unit 305 finishes the caution/information display processing.

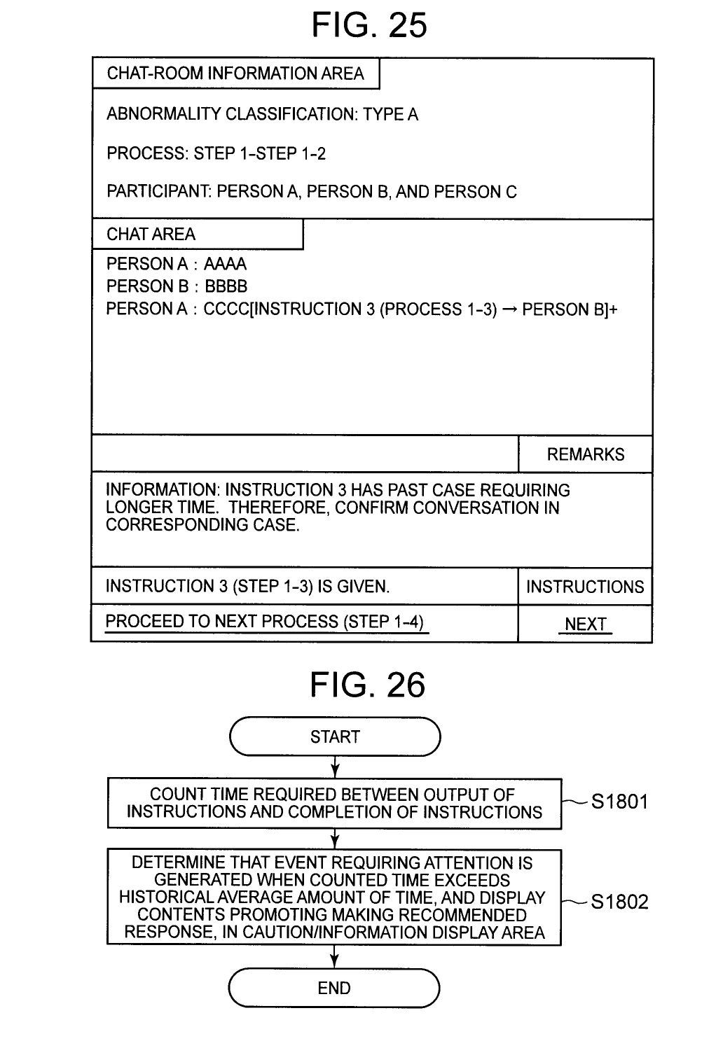

FIG. 25 shows an example of the caution/information display area displaying a response which may have a problem. FIG. 25 is an explanatory diagram showing another example of chat-room screen displayed by the chat-room-screen display unit 301. The caution/information display area showed in FIG. 25 displays caution/information promoting confirmation of a conversation held in a response made in the past by participants, for a next substep for which work is to be performed, since there are cases in which much time is required to make a response.

FIG. 26 is a flowchart showing an operation of another caution/information display processing by the caution/information display unit 305 according to the second exemplary embodiment.

The caution/information display unit 305 measures a time required between the output of instructions and the completion of the instructions (step S1801).

In a case where the measured time significantly exceeds a historical average amount of time included in the response process (substep) data, much time is required to make a response compared with a past case. The caution/information display unit 305 determines that an event requiring attention occurs, and inputs a request to display attention/information in the caution/information display area to the chat-room-screen display unit 301.

The caution/information display unit 305 determines whether a measured time significantly exceeds the historical average amount of time, on the basis of a predetermined threshold value. For example, in a case where a measured time exceeds 150% of the historical average amount of time, the caution/information display unit 305 determines that the measured time significantly exceeds the historical average amount of time.

The chat-room-screen display unit 301 receiving the input of the display request displays a message promoting making a response recommended by the display request, in the caution/information display area (step S1802). After display, the caution/information display unit 305 finishes the caution/information display processing.

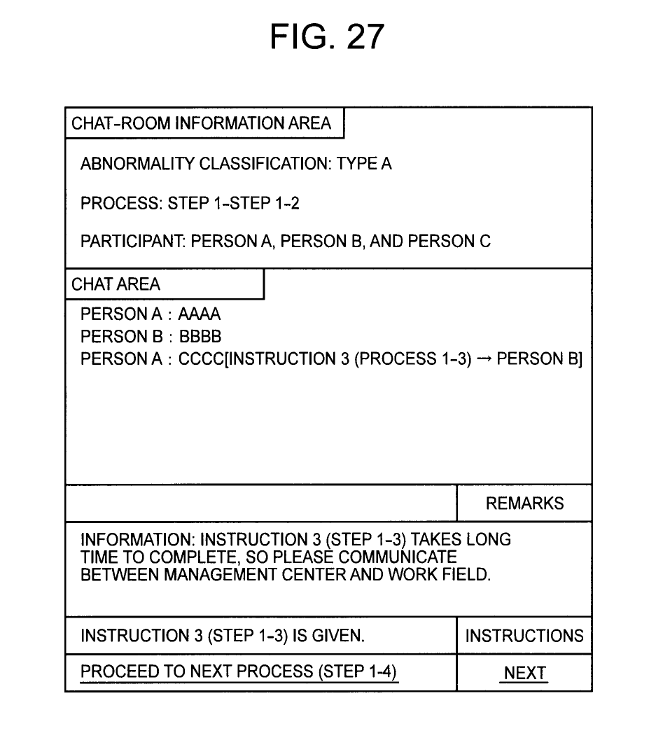

FIG. 27 shows an example of the caution/information display area displaying that a response may have a problem. FIG. 27 is an explanatory diagram showing another example of chat-room screen displayed by the chat-room-screen display unit 301. The caution/information display area showed in FIG. 27 displays caution/information promoting work with mutual understanding between the manager in the management center and a worker in the field, since much time is required to make a response.

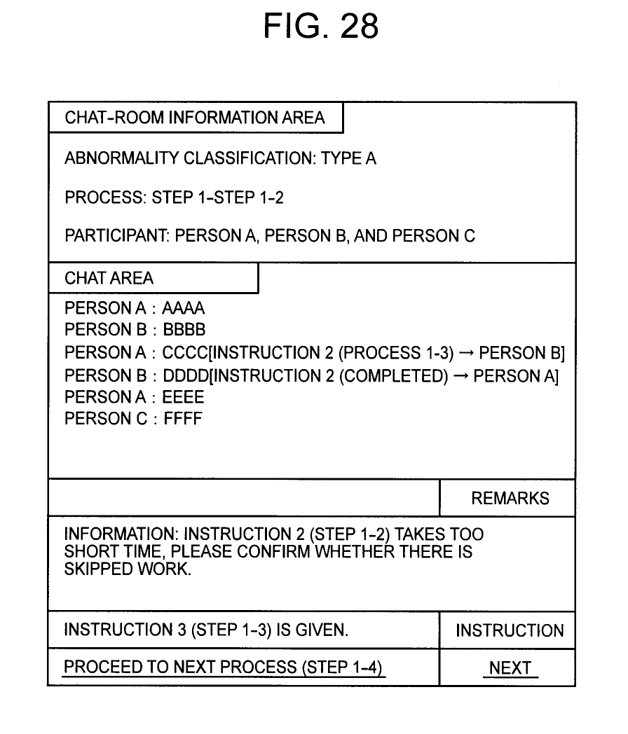

Note that a caution or information may be displayed in the caution/information display area, in a case where a measured time is significantly below a historical average amount of time. FIG. 28 is an explanatory diagram showing another example of chat-room screen displayed by the chat-room-screen display unit 301.

The caution/information display area showed in FIG. 28 displays caution/information promoting confirmation of skipped work before completion of instructions, since skipped work or the like may cause reduction in response time.

Furthermore, the caution/information display unit 305 may cause the caution/information display area to display a historical average amount of time. When instructions are output, the caution/information display unit 305 extracts a historical average amount of time included in response process (substep) data corresponding to the output instructions. The caution/information display unit 305 inputs, to the chat-room-screen display unit 301, a request to display the extracted historical average amount of time in the caution/information display area. The chat-room-screen display unit 301 receiving the input of the display request displays the historical average amount of time in the caution/information display area.

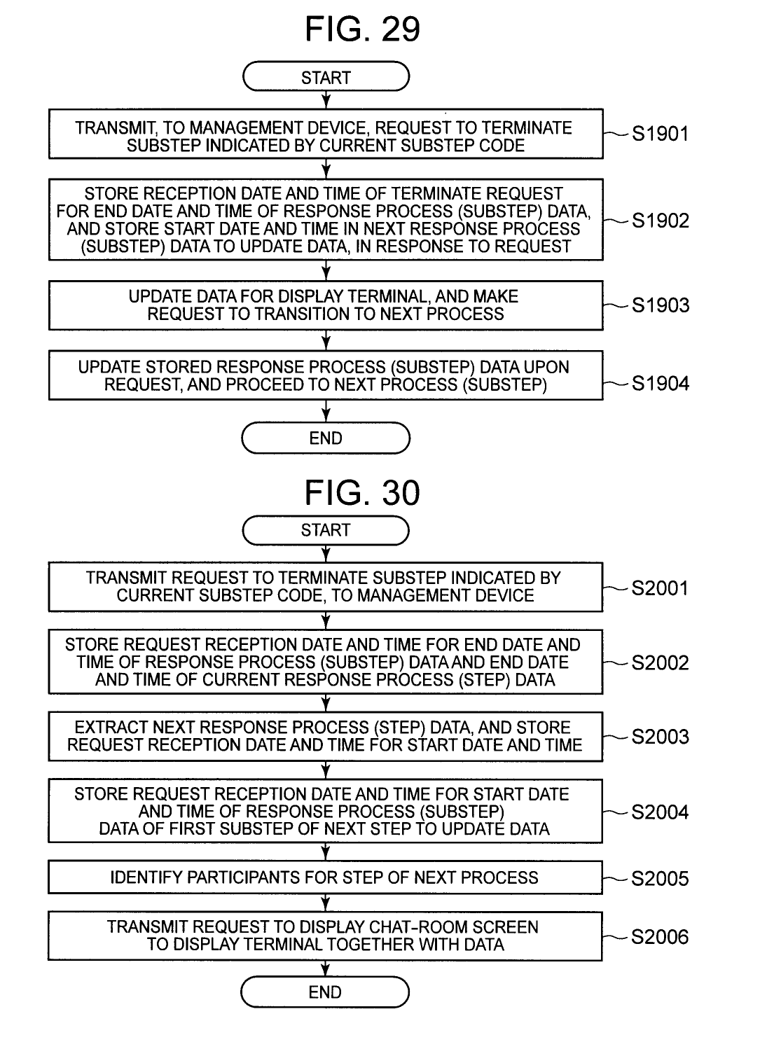

Next, a process to transition work to a next process via the next-process area will be described. FIG. 29 is a flowchart showing an operation of work transition processing by the process management system 100 according to the second exemplary embodiment.

In a case where a process (substep) in which a response is being made has instructions not completed, that is, response process (substep) data has no value stored for instruction completion date and time, the instructions are not yet completed. Therefore, the management device 200 determines that the work is not allowed to proceed to a next process.

In a case where a process (substep) in which a response is being made has instructions completed, that is, the response process (substep) data has a value stored for instruction completion date and time, a staff presses the “next” button displayed in the next-process area, and the work is allowed to proceed to a next process. In a case where the substeps included in a step in which a response is being made include a substep not completed, a next process is a next substep.

In conditions as described above, when the “next” button is pressed, the chat-room-screen display unit 301 transmits, to the management device 200, a request to terminate a substep in which a response is being made, indicated by a substep code (step S1901).

The chat-room management unit 202 of the management device 200 receiving the terminate request stores reception date and time of the terminate request for end date and time of the response process (substep) data. Then, the chat-room management unit 202 extracts a response process (substep) data corresponding to the next substep, stores reception date and time of the terminate request for start date and time, and updates the data (step S1902).

Then, the chat-room management unit 202 transmits a request to update the response process (substep) data and a request to transition to a next process to a display terminal (step S1903). The display terminal receiving the update request and the transition request updates the stored response process (substep) data, and the work proceeds to the next process (substep) (step S1904). After the work proceeds to the next process, the process management system 100 finishes the work transition processing.

FIG. 30 is a flowchart showing an operation of another work transition processing by the process management system 100 according to the second exemplary embodiment. After all substeps constituting a step in which a response is being made are completed, a next process is the first substep constituting a next step.

In conditions as described above, when the “next” button is pressed, the chat-room-screen display unit 301 transmits, to the management device 200, a request to terminate the substep in which a response is being made, indicated by a substep code (step S2001).

The chat-room management unit 202 of the management device 200 receiving the terminate request stores reception date and time of the terminate request for end date and time of a response process (substep) data. Then, the chat-room management unit 202 stores reception date and time of the terminate request for end date and time of a response process (step) data corresponding to the step in which a response is being made (step S2002).

Then, the chat-room management unit 202 extracts a response process (step) data corresponding to the next step, and stores reception date and time of the terminate request for start date and time (step S2003). Then, the chat-room management unit 202 extracts a response process (substep) data corresponding to the first substep constituting the next step, stores reception date and time of the terminate request for start date and time, and updates the data (step S2004).

For the step of the next process, the chat-room management unit 202 identifies participants to the chat room similarly to the identification of the participants in the previous step (step S2005). The chat-room management unit 202 transmits, to display terminals of the identified participants, a request to display the chat-room screen together with data to be used (step S2006). After transmission, the process management system 100 finishes the work transition processing.

When all steps are completed, the response is finished. At the end of the response, the management device 200 transmits a terminate request for termination of the response to each display terminal.

Note that the display terminal according to the present exemplary embodiment is possessed by each staff. In a case where the display terminal is a portable display terminal into which positional-information acquisition means is incorporated, the display terminal can acquire positional information about a worker in the field. That is, a process management system enables understanding of the positions of the staffs.

It is assumed that, in a large facility, such as a plant, a place where an abnormal event occurs is distant from places where workers are positioned. In a case where a worker who makes a response is located far from the place where the abnormal even occurs, time at which instructions are given is not start time of work, and a process management system is required to consider the worker's travel time.

The caution/information display unit 305 according to the present exemplary embodiment displays a caution or information on the basis of a time required between the output of the instructions and the completion of the instructions. The caution/information display unit 305 is configured to consider a time required to travel from a current place of the worker to a work field, and reduce the time required to travel, from a time required between the output of the instructions and the completion of the instructions, and an average amount of time of past work can be more accurately computed. That is, the caution/information display unit 305 is configured to more appropriately display a caution or information.

Furthermore, in the process management system according to the present exemplary embodiment, the process (step) data and the process (substep) data are defined beforehand. A manager gives instructions to perform work in accordance with the contents represented by the process (step) data and the process (substep) data. However, when a response is made to an abnormal event or a sign of an abnormal event, performance of an unexpected work may be required.

When the performance of the unexpected work is required, the manager is allowed to interpose desired instructions between defined process (substep) data and process (substep) data to give instructions, so that the manager can respond to such a situation as described above. Specifically, the manager is allowed to insert desired response process (substep) data between process (substep) data and process (substep) data to give instructions as to work not associated with the predefined process (substep) data.

### Description of Effects

The process management system according to the present exemplary embodiment includes means for exchanging information between staffs when an abnormal event or a sign of an abnormal event occurs. Specifically, the process management system provides chat means as means for exchanging information when an abnormal event is detected in a plant or the like.

Each staff is allowed to give instructions as to work in addition to have a chat (conversation) via a chat screen provided by the chat means. Therefore, transmitted information is not separated from work, and workers using the process management system can efficiently perform work without skipping work.

In the process management system according to the present exemplary embodiment, instructions as to work and a conversation are displayed in one display area, and information exchanged between a manager and workers is not separated from work. Thus, efficiency and accuracy of a response to an abnormal event or a sign of an abnormal event is improved. Furthermore, the process management system manages instructions given as to work and completion of the work, and skipping instructions or work can be avoided.

Furthermore, information exchanged between a manager and workers includes information representing a work process. Thus, the manager is allowed to clearly understand the progress of work, and also allowed to give instructions as to work of a next process from a display terminal. Furthermore, a worker is allowed to report the completion of work whenever one process is completed, and a working status is readily specifically transmitted to a manager.

Furthermore, the process management system according to the present exemplary embodiment records a chat as well as instructions as to work. The process management system uses a past response record to provide an opportunity to understand work or situation requiring attention. That is, use of the process management system enables workers to refer to a past chat history between the output of instructions and the completion of the instructions, efficiently performing work. Use of information such as a time required between the output of instructions and the completion of the instructions in the past effectively enables workers to efficiently perform work in which a response is being made.

Furthermore, the report generation unit according to the present exemplary embodiment can generate a report including chat contents. That is, a user of the process management system does not need to generate a report.

Note that the management device 20, the display device 30₁ to display device 30ₙ, the management device 200, and the display terminal 300 according to each exemplary embodiment are achieved, for example, by a central processing unit (CPU) executing a process in accordance with a program stored in a non-transitory recording medium. That is, the management reception unit 21, the management transmission unit 22, the input unit 31, the display transmission unit 32, the display reception unit 33, the display unit 34, the work/response data extraction unit 201, the chat-room management unit 202, the report generation unit 203, the chat-room screen display unit 301, the abnormality classification display unit 302, the process display unit 303, the instruction display unit 304, and the caution/information display unit 305 are achieved, for example, by a CPU executing a process in accordance with program control.

Furthermore, the abnormal/abnormal sign classification-relating data storage unit 204, the process-relating data storage unit 205, the staff-relating data storage unit 206, and the response-relating data storage unit 207 are achieved, for example, by a random access memory (RAM).

Furthermore, each unit of the management device 20, the display device 30₁ to display device 30ₙ, the management device 200, and the display terminal 300 according to each exemplary embodiment may be achieved by a hardware circuit.

It should be understood that although the present invention has been described above with reference to the exemplary embodiments, the present invention is not limited to the exemplary embodiments described above. Various changes and modifications which can be understood by a person skilled in the art may be made to the configurations and details of the present invention within the scope of the present invention.

The present application is based on and claims the benefit of priority from Japanese Patent Application No. 2016-048273 filed on Mar. 11, 2016, the disclosure of which is incorporated herein in its entirety by reference.

### INDUSTRIAL APPLICABILITY

The present invention may be preferably applied to make a response to a detected event when an abnormal event or a sign of an abnormal event is detected in a plant such as an electrical power plant.

### REFERENCE SIGNS LIST

10, 100 Process management system
20, 200 Management device
21 Management reception unit
22 Management transmission unit
30₁ to 30ₙ Display device
31 Input unit
32 Display transmission unit
33 Display reception unit
34 Display unit
201 Work/response data extraction unit
202 Chat-room management unit
203 Report generation unit
204 Abnormal/abnormal sign classification-relating data storage unit
205 Process-relating data storage unit
206 Staff-relating data storage unit
207 Response-relating data storage unit
212 Caution/information data analysis unit
222 Process management unit
300, 310, 320 Display terminal
301 Chat-room-screen display unit
302 Abnormality classification display unit
303 Process display unit
304 Instruction display unit
305 Caution/information display unit

What is claimed is:

1. A process management system comprising:
a management device which manages work; and
a display device which is connected so as to be able to communicate with the management device,
wherein the management device includes:
a management reception unit which receives work-related information transmitted from the display device; and
a management transmission unit which transmits, to the display device, process information indicating work process and the work-related information received by the management reception unit, and
the display device includes:
an input unit to which the work-related information is input;
a display transmission unit which transmits the received work-related information to the management device;
a display reception unit which receives the information transmitted from the management transmission unit; and
a display unit which displays the input work-related information and the information received by the display reception unit in one display area.

2. The process management system according to claim 1, wherein
the management transmission unit transmits past information indicating a past working status to the display device.

3. The process management system according to claim 2, wherein
the management transmission unit transmits difference information indicating a difference between a working status indicated by past information and a working status indicated by work-related information received by the management reception unit to the display device.

4. The process management system according to claim 1, wherein
the management transmission unit transmits work information indicating contents of the whole work to the display device.

5. The process management system according to claim 1, wherein
the management transmission unit transmits caution information indicating a caution relating to work to the display device.

6. The process management system according to claim 1, wherein
the input unit receives input of instruction information indicating instructions to perform a process of work to be performed.

7. The process management system according to claim 1, wherein
the input unit receives input of completion information indicating completion of a process of work.

8. The process management system according to claim 1, wherein
the management device includes a generation unit which generates a report on the basis of work-related information received by the management reception unit.

9. A process management method performed in a process management system including a management device which manages work, and a display device which is connected so as to be able to communicate with the management device, the method comprising:
causing the management device to
receive work-related information transmitted from the display device, and
transmit, to the display device, process information indicating work process and the received work-related information, and
causing the display device to
receive the work-related information,
transmit the received work-related information to the management device,
receive the information transmitted from the management device, and
display the received work-related information and the received information in one display area.

10. The process management method according to claim 9, wherein
the management device transmits past information indicating a past working status to the display device.

11. The process management system according to claim 2, wherein
the management transmission unit transmits work information indicating contents of the whole work to the display device.

12. The process management system according to claim 3, wherein
the management transmission unit transmits work information indicating contents of the whole work to the display device.

13. The process management system according to claim 2, wherein
the management transmission unit transmits caution information indicating a caution relating to work to the display device.

14. The process management system according to claim 3, wherein
the management transmission unit transmits caution information indicating a caution relating to work to the display device.

15. The process management system according to claim 4, wherein
the management transmission unit transmits caution information indicating a caution relating to work to the display device.

16. The process management system according to claim 11, wherein
the management transmission unit transmits caution information indicating a caution relating to work to the display device.

17. The process management system according to claim 12, wherein
the management transmission unit transmits caution information indicating a caution relating to work to the display device.

18. The process management system according to claim 2, wherein
the input unit receives input of instruction information indicating instructions to perform a process of work to be performed.

19. The process management system according to claim 3, wherein
the input unit receives input of instruction information indicating instructions to perform a process of work to be performed.

20. The process management system according to claim 4, wherein
the input unit receives input of instruction information indicating instructions to perform a process of work to be performed.
